(19) United States
(12) Patent Application Publication
(10) Pub. No.: US 2014/0142993 A1
(43) Pub. Date: May 22, 2014

(54) Talent Booking System and Method

(71) Applicant: John Sanders, Cordova, TN (US)

(72) Inventor: John Sanders, Cordova, TN (US)

(21) Appl. No.: 13/934,037

(22) Filed: Jul. 2, 2013

Related U.S. Application Data
(63) Continuation-in-part of application No. 12/959,212, filed on Dec. 2, 2010, now abandoned.

(51) Int. Cl. G06Q 10/02

(52) U.S. Cl. CPC G06Q 10/02
USPC 705/5

(57) ABSTRACT

A method of booking talent is provided, comprising: storing a plurality of talent files on a data storage system, each of the talent files being categorized based on select criteria, and wherein each talent file contains talent information associated with one of a plurality of performing artists; searching the data storage system through a processing device operatively coupled to the data storage system for processing requests for the talent files and the talent information; communicating requests for the talent files and the talent information through a user interface operatively coupled to the processing device, and communicating the talent files and talent information to a system user; selecting one or more talent files for possible booking of the corresponding performing artist; making an offer to book one or more of the performing artists for a performance having specified terms; and receiving a response to the offer from the performing artist. Upon agreement, the method further comprises consummating an electronic monetary transaction related to the offer between the system user and the performing artist.

### CROSS-REFERENCE TO RELATED APPLICATIONS

This continuation-in-part patent application claims priority under 35 U.S.C. §120 to U.S. Ser. No. 12/959,212, filed on Dec. 2, 2010, which claims priority under 35 U.S.C. §119 to U.S. provisional application Ser. No. 61/394,608, filed on Oct. 19, 2010.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON COMPACT DISC

Not applicable.

### BACKGROUND OF THE INVENTION

1. Field of the Invention

The present invention relates to methods and systems for matching talent (such as musical artists, actors, and other performers) to persons seeking such talent, and more particularly to such methods and systems which allow electronic negotiation of the terms of the talent contract and subsequent booking of such talent.

2. Description of Related Art

Numerous daily transactions which used to require telephone calls, meetings, and various human intermediaries are now handled almost entirely electronically, including music downloads, travel booking, car rentals, and the like. However, in the talent booking industry, the process of booking a musical group or a performing artist (the “talent”) has not changed for many years, and has not sufficiently embraced modern communication technologies. When a person seeks talent for a particular event (a “buyer”), the buyer typically must speak with someone hired by the talent (an “agent”) to arrange such bookings and negotiate the terms of the performance. In some instances, those communications may enable the buyer to submit certain information or an offer to the agent electronically. But, the buyer still has to deal with agents and other persons who might easily manipulate the buyer and steer the discussions toward arrangements and terms which do not always keep the best interests of the talent in mind.

The talent booking process has remained archaic for a couple of reasons. First, as with many transactions, it has always been conducted in the manner just described. Second, no one has yet provided a better system that works for all of the participants in the transaction, e.g. the buyer, the agent, and the talent.

Currently, if a talent buyer chooses to book a particular group or artist, the buyer must first research how to contact the talent or its agent. While such a task would seem fairly trivial, many artists and their agents are careful to limit their ability to be contacted, in part because such agents and talent desire varying levels of exclusivity. Therefore, the process of communicating with the right persons can be time-consuming and tricky. For example, many performing artists, particularly the very well known and popular established performing artists, do not always want their information shared, distributed, or otherwise provided to anyone other than specifically authorized buyers. This is a common circumstance for well known actors who wish to maintain positive and vigilant control over access by the public to the actor's image, likeness, etc. Talent agents and agencies similarly generally do not want their information, e.g., the information of their clients, shared or otherwise accessed or used without specific authorization. This also includes the common desire among agencies for their talent information to be kept exclusive, and not provided to other agents or agencies not within or affiliated with their agency.

However, if the buyer does not know who they wish to hire, he must spend time researching various artists based on desired criteria, or he must take a particular agency's advice of available groups or artists on its roster. But even if a buyer finds an option of several available artists, the buyer must make contact with the agency representing the talent to start the negotiation and booking process. In those instances, it is likely that the buyer may need to communicate with multiple agencies in the process.

Dealing with an agent can be a lengthy and frustrating process, because the buyer must often engage in negotiations simply to get the agent to take any action toward the potential booking. In most instances, the talent is unaware that this “haggling” is even taking place. For example, in an effort for a particular agency to gain favor with an artist management and make more money for themselves, the agent may demand higher than normal revenues. In other words, the pricing structure may be out of line with talent having similar frame and/or success. Also, if an agent learns that the buyer has greater financial resources, the agent may demand higher than normal prices which are not necessarily reflective of the artist's worth. Furthermore, the agent may accept another buyer's offer for less because of a personal relationship or for other favors. Therefore, the buyer's success in booking the talent will be determined if and when a particular agency chooses to accept an offer for the talent he represents. While such a process is certainly challenging for concert promoters, producers, and other entertainment professionals, it is particularly daunting for the novice PTA member or church organization that chooses to promote an event requiring one or more performing artists.

In addition, and from the agency's perspective, the agents are serving all of their clients on their particular roster. Over the years this has created a “caste system” of artists, where artists on the lower end of that system are commonly referred to as “indie artists”. Moreover, artists on each roster are often given a success designation of A, B or C determined by the agency based upon the artist's success in the marketplace. While this may have served a purpose for many years, such a process promotes imbalances in the marketplace, and lost opportunities for emerging artists. Talented, but less famous, artists have to get to the “elite” level in the eyes of the agency to even have a shot at having a viable career, even though there may be more than enough potential events in the marketplace for such artists to build a thriving career.

Finally, the passage of time (sometimes measured in weeks or months) in the conventional booking process often results in missed bookings for the desired talent, or the buyer having to settle for talent that is not ideal for the occasion. In the age of the Internet, mobile wireless devices, and immediate communication, the conventional talent booking process has quickly become a vestige of the past. For the talent industry to keep pace with technology and demand, it must embrace new methods of communication between buyers, talent, and their agents.

To better the problems, the conventional system for booking talent is further outlined below with regard to the inefficiencies and disadvantages for the parties involved, with the exception of the “gatekeeper” agency. The agency currently controls live events similar to how record companies controlled music before the Internet/technology boom. One of the key differences is that with music and video, buyers are dealing with a tangible asset of a particular piece of music or video. However, with live events requiring a performing artist, the buyer is dealing with the use of services.

Talent

Many artists, including bands and speakers, get little to no attention on an agency's roster. For example, there may be only a few agents at a particular agency, and those agents may be representing 40 or more artists. Logically enough, the agents spend most of their time on the artists making them the most money. Therefore, many artists simply cannot make the wages needed to support their careers in the marketplace. Many more artists should be able to support themselves with performance dates (or “gigs”). However, the conventional and outdated booking system, in the midst of a surge of new artists in the market, has not and cannot keep up with the level of dates needed to support higher levels of artists in the marketplace. One of the difficulties that artists have in negotiating a booking contract with a particular agency is that the agency requires that the group be exclusive with their particular agency. This has always favored the agency who makes its wages from as many artists as it chooses to book. There is currently no way for willing talent worthy of more bookings to increase its activity other than being at the mercy of the booking agency. In other words, the talent only makes income from their particular dates. The agency makes its income from all the artists on its roster. Should the agency need more income, it can always find a new artist to book.

Further complicating the situation, many artists have “prime” dates that typically pay a premium. These dates may include weekends, many holidays, and any special occasions. There are also off-dates where gig fees are much harder to come by. Many agencies pick the “ripe fruit” (prime dates) while promising to pursue gigs on the off-dates. However, most typically fall short and do not have a system in place to handle this. As should be apparent, booking off-dates would be extremely beneficial for any talent. However, the fact that it is not a “prime” date can many times be a demotivating factor for any agency who can pick up another group and book the prime dates for them as well. Even if an artist is getting the majority attention from their particular agency for bookings, the agencies still have a limited amount of time, typically 9 am-5 pm, Monday-Friday, with no holidays or weekends.

Buyer/Promoter

Buyers and promoters are at the mercy of the agency representing the talent. The agent is a gatekeeper and may not be representing the artist in a manner that serves the artist's best interests. With respect to a particular event, the buyer and artist simply have to trust that the agency is working fairly to assist the transaction. Misrepresentations of information are common, such as embellishing record sale numbers to buyers who would not be privy to that information, as well as the number of top songs, and demand in the marketplace. Also, an agent may convey misinformation about a buyer to an artist or their management, and there is no way the buyer would be aware of such misinformation.

Furthermore, instead of focusing on becoming a better promoter by successfully promoting a concert or event, promoters are forced into unfair competitions against other promoters to gain favor from a particular agency. This often occurs in the hope of being awarded the right to promote a particular artist. In the radio industry, this is sometimes referred to as “pay-o-la”.

Also, the conventional booking process introduces factors into the negotiation process that do not always reflect the fair market value for the talent services. For example, if a buyer wishes to book an artist, the agent may simply decline a particular offer for any number of reasons that may range from discrimination, relationships with other buyers or artists, or because they simply are demanding a higher commission. Many times these decisions are being made without the knowledge of the artist or the buyer.

As noted previously, the quicker talent can be booked, the easier the transaction is for all of the parties. However, many booking agencies take weeks or months to make counteroffers, accept, or even respond to an offer. Of course, this makes timely bookings difficult, if not impossible. In many cases, business opportunities for artists (and their agents) are lost, simply because of the time-consuming delays of conventional booking methods.

Finally, there are distinct disadvantages for first-time or infrequent buyers and promoters in the current talent booking world. The industry will always have many such novice buyers for several reasons, e.g., a year-end party, a one-time event, a church program, and the like. Most novice buyers are at a serious disadvantage from agents who take advantage of their limited expertise and often sell those buyers talent that doesn't fit their needs and desires, especially from a financial perspective.

Consumer

The current structure of talent booking does not allow fair market value to drive the transaction. Therefore, there is a tendency for artists to lose opportunities to acquire the best platform and events needed for them to rise to their maximum potential. In the entertainment business, it is yet another deterrent to having top-notch (but otherwise unknown) talent naturally rise to the top of the industry. Consequently, consumers of music and other fruits of such talent do not see the “best of the best” in a free market enterprise.

Entire Industry and Economy

By limiting the access to groups and artists by “gatekeeping” agents, this effectively allows agents and agencies to control supply and demand, rather than letting the free market forces determine who gets gigs and what terms are applicable. All potential buyers are forced to use agents in the conventional booking process and must deal with the inefficiencies and disadvantages explained above.

With the digital technology advancement and the increase use of the Internet, the supply of artists, bands, and other talent has increased exponentially. In order to prevent the supply from outpacing the demand, a new fair market approach must be utilized by: (1) fully embracing modern technology, (2) allowing buyers and artists to communicate more directly with one another to meet the needs of both. If this can be accomplished, the number of jobs and revenue that will flow to this new over-supplied marketplace of artists will be highly beneficial for bands, artists, speakers, buyers, promoters, consumers and the entire industry.

### SUMMARY OF THE INVENTION

Therefore, a system and method of booking talent is provided, comprising: (a) storing a plurality of talent files on a data storage system, each of the talent files being categorized based on select criteria, and wherein each talent file contains talent information associated with one of a plurality of performing artists; (b) searching the data storage system through a processing device operatively coupled to the data storage system for processing requests for the talent files and the talent information; (c) communicating requests for the talent files and the talent information through a user interface operatively coupled to the processing device, and communicating the talent files and talent information to a system user; (d) selecting one or more talent files for possible booking of the corresponding performing artist; (e) making an offer to book one or more of the performing artists for a performance having specified terms; and (f) receiving a response to the offer from the performing artist.

If the buyer and artist have reached an agreement, then the method would further comprise consummating an electronic monetary transaction related to the offer between the system user and the performing artist.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 depicts a broad overview of a talent booking system in accordance with the present invention.

FIG. 1a depicts the overall delivery architecture of the invention, including a virtual cloud hosting environment and Internet delivery system.

FIG. 1b is a detail of the Clustered Server Configuration hosting environment as identified in FIG. 1a.

FIGS. 2a through 3d are examples displays of a possible software implementation of the invention.

FIG. 4 depicts an image of a possible display as delivered on a mobile device.

FIG. 5 depicts a workflow chart illustrating the overall process for an end user making an artist search and making an offer.

FIG. 6 depicts a workflow chart illustrating an end user's specific artist search.

FIG. 7 depicts a workflow chart illustrating an end user's non-specific artist search.

FIG. 8 depicts a workflow chart illustrating an end user making an offer.

FIG. 9 depicts a workflow chart illustrating an artist's (talent) response to an offer.

FIG. 10 depicts a workflow chart illustrating an artist's (talent) response to a bid.

FIG. 11 depicts a workflow chart illustrating an artist's (talent) response to multiple bids (offer/counteroffer).

FIG. 12 depicts a transactional workflow chart illustrating the processes and options of an end user making an offer.

FIG. 13 depicts a transactional workflow chart illustrating the processes and options of an artist accepting an offer.

FIG. 14 depicts a workflow chart illustrating the financial processes for an end user submitting a booking request.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

System Architecture and General Functionality

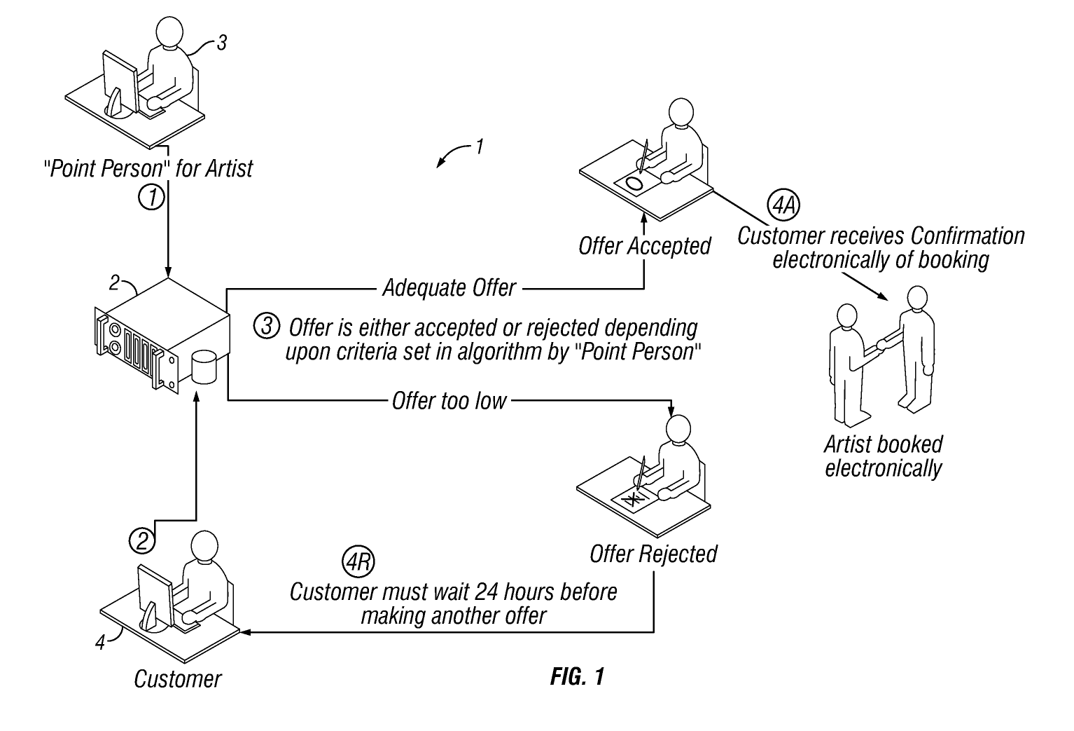

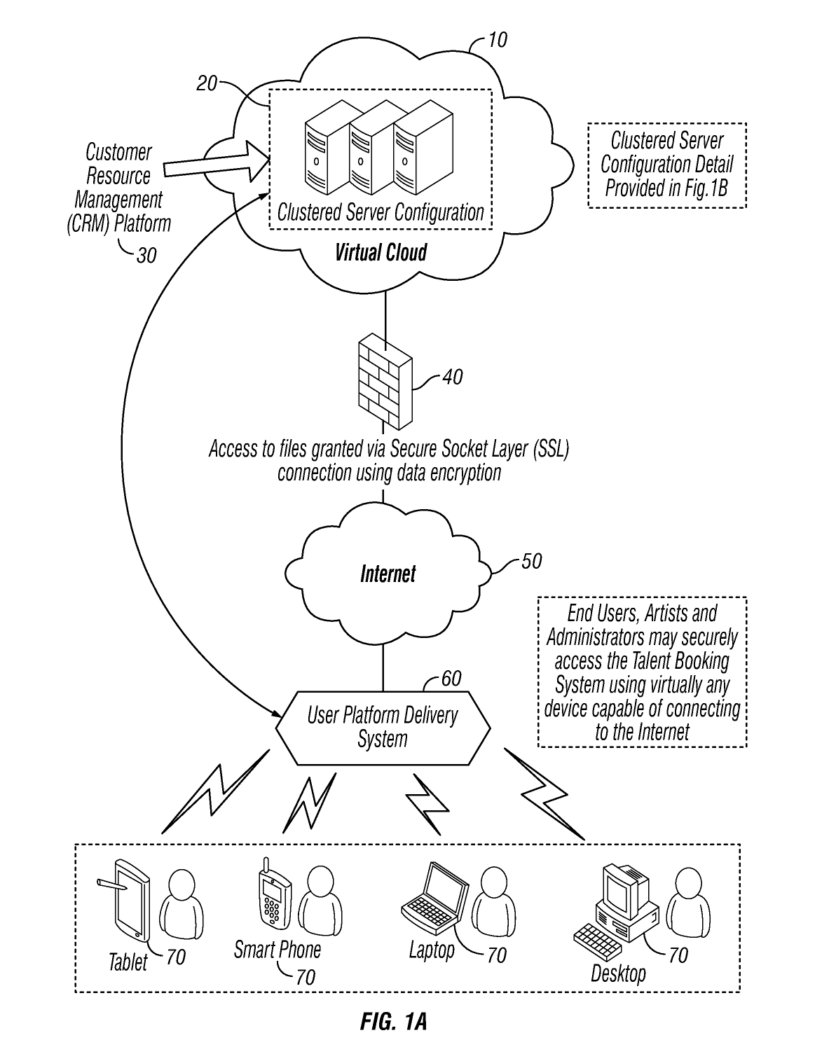

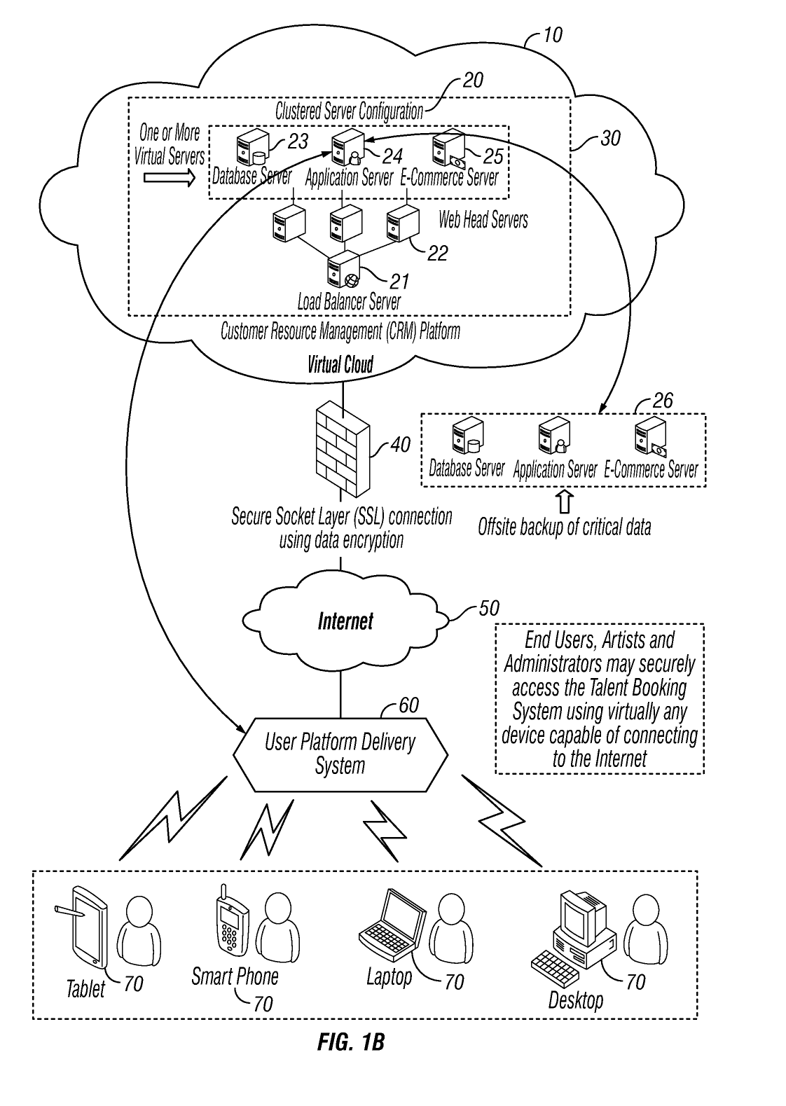

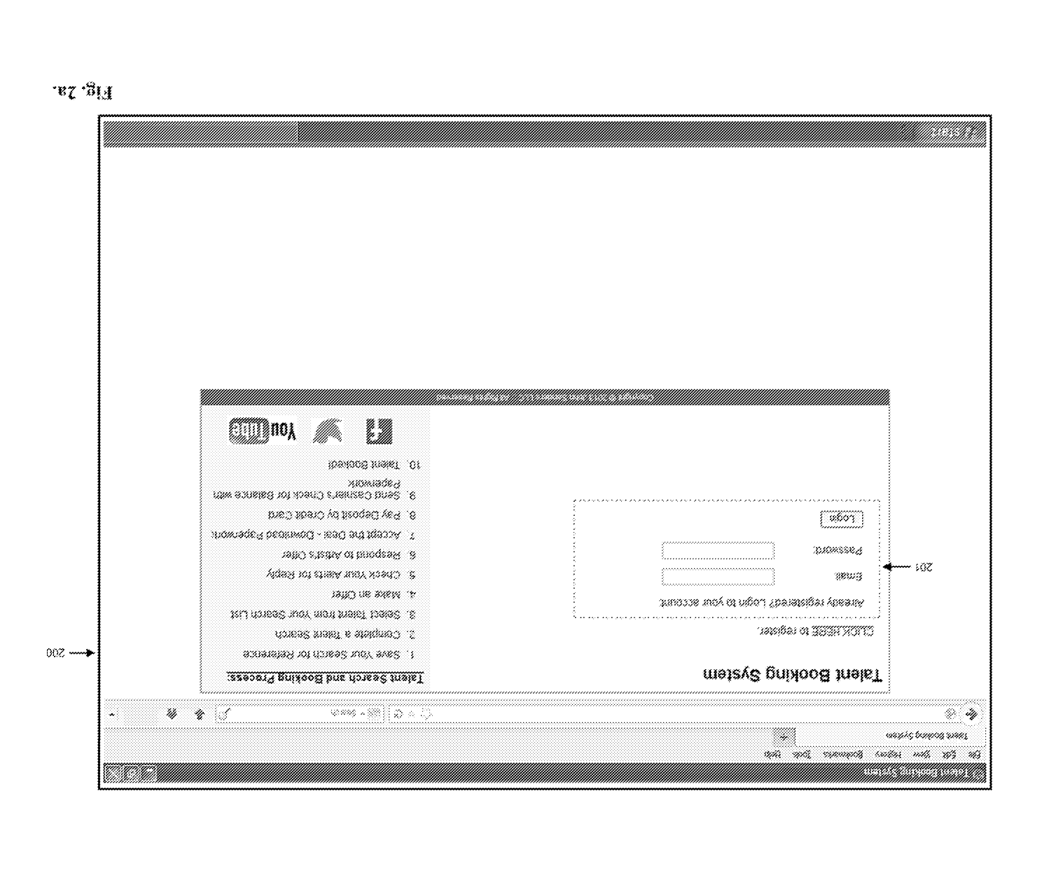

Turning now to FIG. 1, in a preferred embodiment of the present invention, a talent booking system 1 and method are illustrated. The system 1 for booking talent generally comprises the following elements. First, a data storage and processing system 2 is provided for storing a plurality of talent files and for processing requests for the talent files and the talent information. Each of the talent files are categorized based on select criteria, and each talent file contains talent information associated with one of a plurality of performing artists 3. In a preferred embodiment, such data storage and processing device 2 may be software running on suitable computer hardware and communicating over a wide area network, such as the Internet 50 and the world wide web (the “web”).

FIG. 1a and FIG. 1b depicts the overall delivery architecture of the talent booking system, including its virtual cloud hosting environment 10 and Internet delivery system. The virtual cloud 10 is a fully-managed (24/7/365) hardware and network infrastructure delivered over the Internet, allowing the flexible delivery of Software as a Service (SaaS) business model and delivered across an array of scalable virtual servers. A typical vendor of virtual cloud services would be Rackspace.com.

The Clustered Server Configuration 20 is an array of virtual (scalable) servers provided by a virtual cloud service 10. The servers within the talent booking system may include a Load Balancer server 21, Web Head server 22, Application server 24, E-commerce server 25, and Database servers 23, shown more particularly in FIG. 1b. The Load Balancing Server 21 distributes queries coming into/out of the Application 24 to the Web Head 22 most capable of handling the query. The Web Head servers 22 provide the processing power to manage the queries, and they may be “cloned” to any number, depending on the traffic anticipated. The Database(s) servers 23 contain the tables where data is stored. The Application server 24 hosts the program that governs the application—that is, all the pages necessary to provide the functionality for the talent booking system in accordance with the invention. The E-Commerce server 25 allows secure financial transactions, and this server will be hosted within a separate, secure environment. The Offsite Backup server 26 is an automatic system of cloning images of the critical servers, located within a separate data center.

A Customer Resource Management (CRM) system 30 is a software platform upon which the talent booking system is built (programmed). The CRM system 30, delivered across the Internet 50, allows administrators to log in and make changes to pages and control parameters.

Secure Socket Layer (SSL) 40 is a cryptographic protocol that provides secure access over the Internet. SSL uses asymmetric cryptography for authentication of key exchange, symmetric encryption for confidentiality and message authentication codes for message integrity. The public Internet 50 is used as the access method for the talent booking system because, after secure logon, it provides practically universal access for all variety of users.

The User Platform Delivery System 60 is a method of adjusting the browser experience dependent upon the type of device used for access. Thus users, such as end users, artists, and administrators, using an iPhone or other device 70 will receive a set of pages optimized for the device's browsing requirements. This set of pages may differ from a user accessing the talent booking system from a personal computer, tablet, or laptop.

With respect to FIG. 1, a user interface is also operatively coupled to the processing system 2 for communicating the requests for the talent files and the talent information, and for communicating the talent files and talent information to a system user 4. The system user 4 would typically be a buyer of talent, and may include promoters or other persons desiring talent for a particular event. In a preferred embodiment, the user interface would comprise a web-based software graphical user interface using HTML, XML, or other coding language operable within a conventional software browser application.

Importantly, an access control system is also provided which is operative with the processing device for enabling access to the stored talent file by an authorized system user 4. Such access control system would include common security restrictions, such as user names and passwords, to control access to the system by only those who are authorized.

Finally, in the most basic embodiment of the present invention, a booking means is required for enabling the system user 4 to make an offer to one or more of the performing artists 3 for a performance having specified terms, and for enabling an electronic monetary transaction related to the offer to be consummated between the system user 4 and the performing artist 3. Typically, the transaction could be completed using common e-commerce software operating in connection with the data storage system and other elements of the overall system.

To accommodate buyers 4 who do not have a particular artist 3 in mind, the system 1 further comprises searching means for enabling the system user 4 to conduct a search of the stored talent files based on the select criteria, and for creating search results; and search output means for outputting the search results to the system user 4. While searches could be made using almost any parameter, some of the more relevant search criteria may involve artist name, performance type, location, price, rating, genre, and availability.

Additional features of the system 1 may also include means for enabling the system user 4 to access one or more of the talent files for a limited period of time Likewise, the access control device may include means for enabling the system user 4 to access one or more of the talent files for a limited number of accesses. Still another feature may be enabling the system user 4 to access a limited portion of one or more of the talent files.

While many of the specific features of the talent booking system 1 are directed to the buyer 4 as a user of the system, it is important that the access control means also enable the performing artists 3 to access and edit their respective talent files; receive and respond to offers from system users 4; and update their schedule, availability, and desired contract terms. For example, a performing artist 3 must be able to accept, reject, or make a counteroffer in response to the offer from the buyer 4. In many cases, the performing artist 3 has “off days” available for which the acceptable fees may be lower than “peak days”. Thus, the performing artist 3 would be able to identify those days and predetermined criteria of an acceptable offer, such as available dates, price, and other conditions specific to those “off days”. The buyer 4 would see those predetermined criteria, and would be able to quickly select the desired date and make the offer consistent with those performance terms. Such bookings would beneficially limit the “haggling” delays by eliminating uncertainty of price and other conditions for both the buyer 4 and the performing artist 3.

The booking means should include a notification device configured to notify the system user 4 of confirmation of a booking, rejection of the offer, or proposed terms of the counteroffer. Timely notifications in the booking process are critical, depending on the circumstances, and such notifications will allow buyers 4 and artists 3 to quickly communicate with one another to close the negotiations for the booking.

To facilitate the negotiations, it is preferable that the booking means includes a plurality of predefined booking contract terms and options which are selectable by the system user 4 and the performing artists 3. Recognizing that many booking contracts contain standard or “boilerplate” terms and conditions, these common terms can be easily identified as options in the offer which can be checked or selected before sending the offer to the artist 3. Likewise, the artist 3 should have access to such predefined terms and conditions, such that if a counteroffer is made, those preferred terms can be selected and sent back to the buyer 4.

Once the booking is consummated and the performing artist 3 has provided the services, a rating device within the booking system 1 would be operatively coupled to the user interface for rating the performance of the performing artists 3 based upon predefined criteria. For example, various qualities of the performance or the transaction can be valued on a scale of 1-10, or comments can be made, similar to that of other well-known e-commerce businesses.

In addition to the booking system described above, a method of booking talent is also provided, comprising the following steps of: (a) storing a plurality of talent files on a data storage system 1, each of the talent files being categorized based on select criteria, and wherein each talent file contains talent information associated with one of a plurality of performing artists 3; (b) searching the data storage system 2 through a processing device operatively coupled to the data storage system 2 for processing requests for the talent files and the talent information; (c) communicating requests for the talent files and the talent information through a user interface operatively coupled to the processing device, and communicating the talent files and talent information to a system user 4; (d) selecting one or more talent files for possible booking of the corresponding performing artist 3; (e) making an offer to book one or more of the performing artists 3 for a performance having specified terms; and (f) receiving a response to the offer from the performing artist 3.

If the buyer 4 and artist 3 have reached an agreement, then the method would further comprise consummating an electronic monetary transaction related to the offer between the system user 4 and the performing artist 3.

With regard to searching, the artists 3 may be searched based upon the select criteria, which would include at least artist name, performance type, location, price, rating, genre, and availability.

The method may further comprise reviewing the response from the performing artist 3 in the form of an acceptance, a rejection, or a counteroffer; confirming the booking with the performing artist 3 if the response was an acceptance; selecting a different performing artist 3 if the response is a rejection; and accepting or rejecting the proposed terms if the response was a counteroffer.

In one embodiment, the offer for booking and the response by a performing artist 3 are made based upon a plurality of predefined booking contract terms and options which are selectable by a system user 4 and the performing artists 3.

As explained previously herein with respect to the system itself, the method may further comprise rating the performance of the performing artists 3 based upon predefined criteria.

Example Displays for a Preferred Embodiment

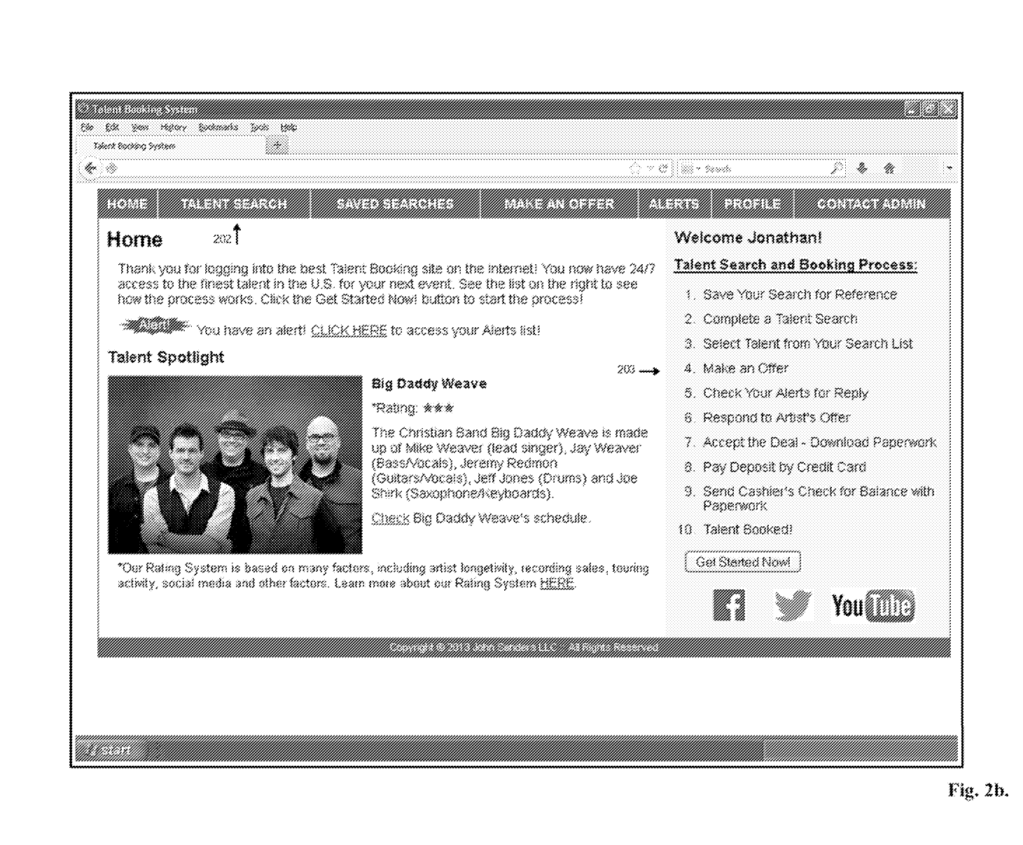

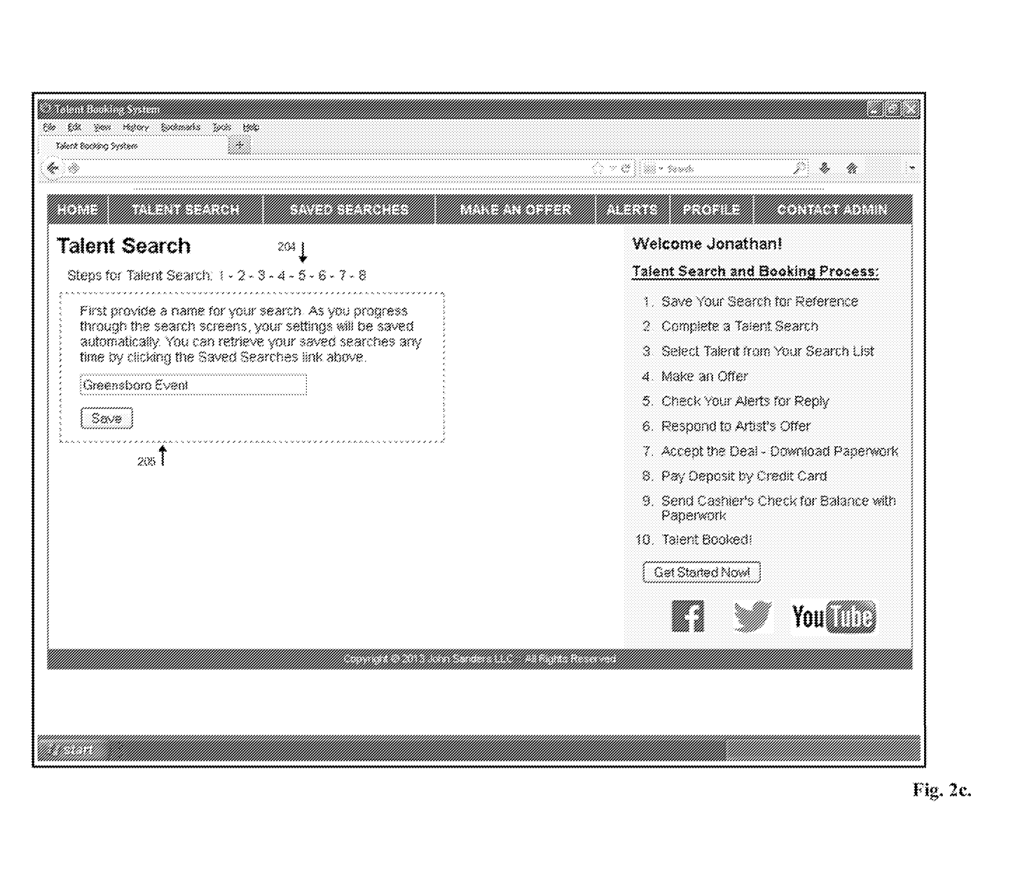

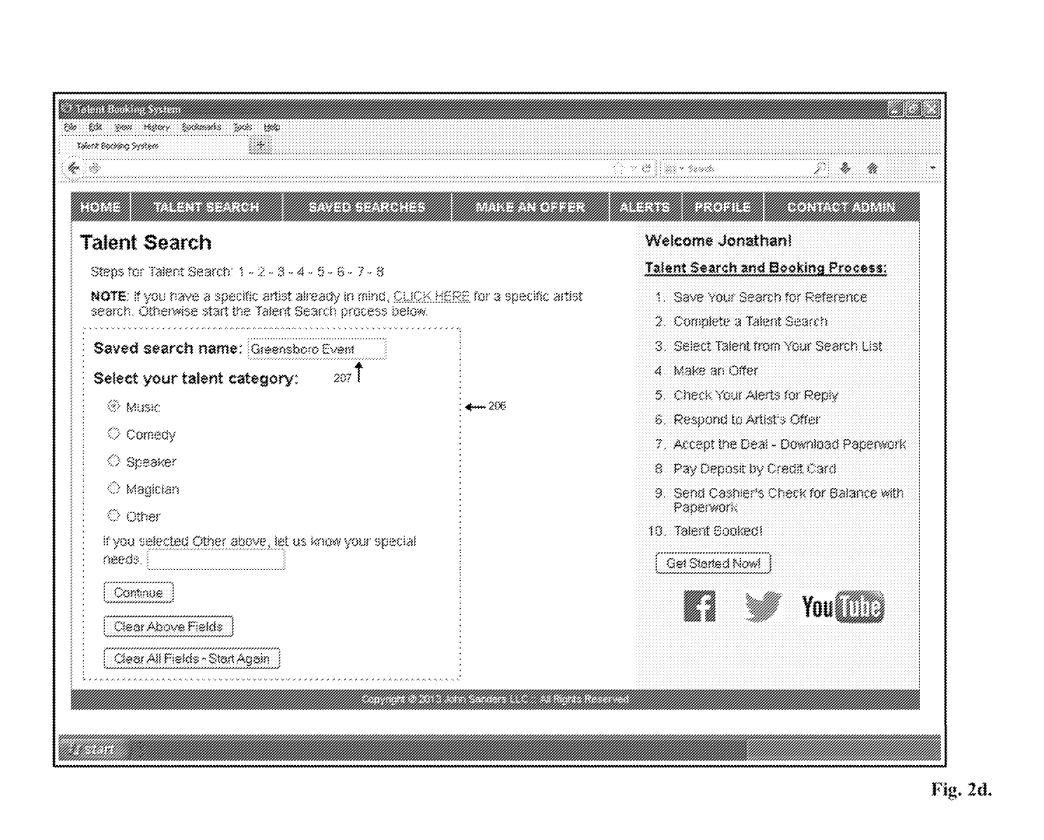

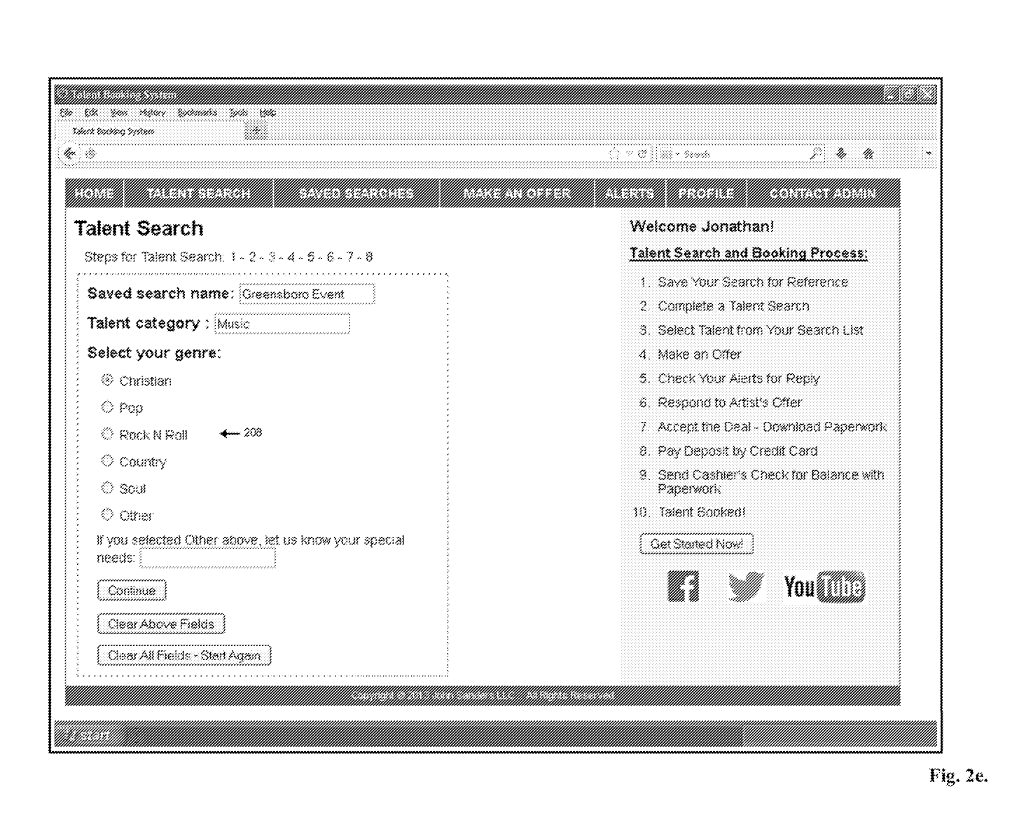

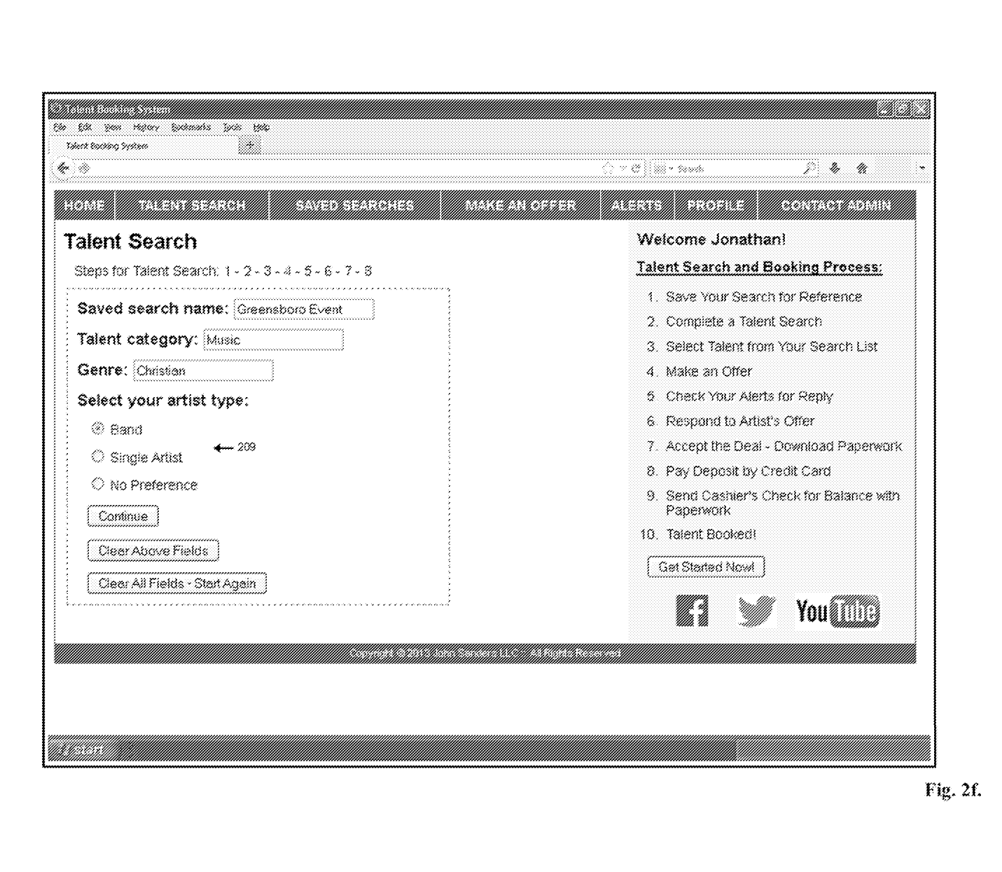

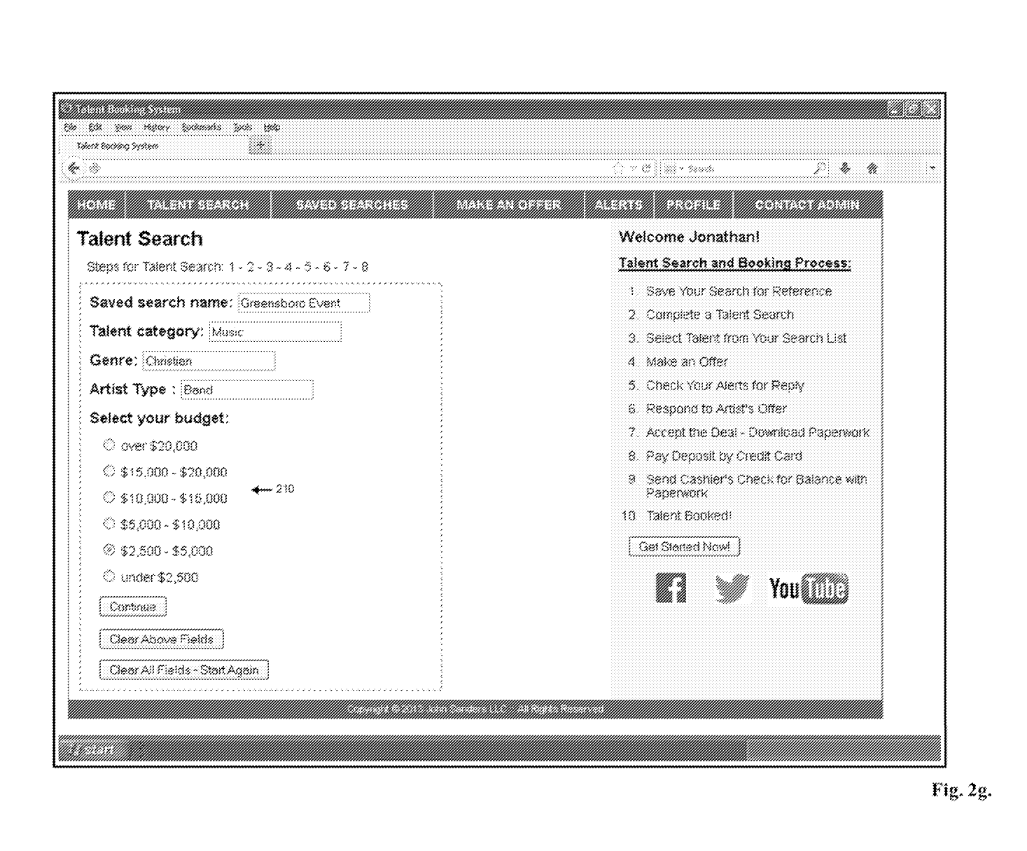

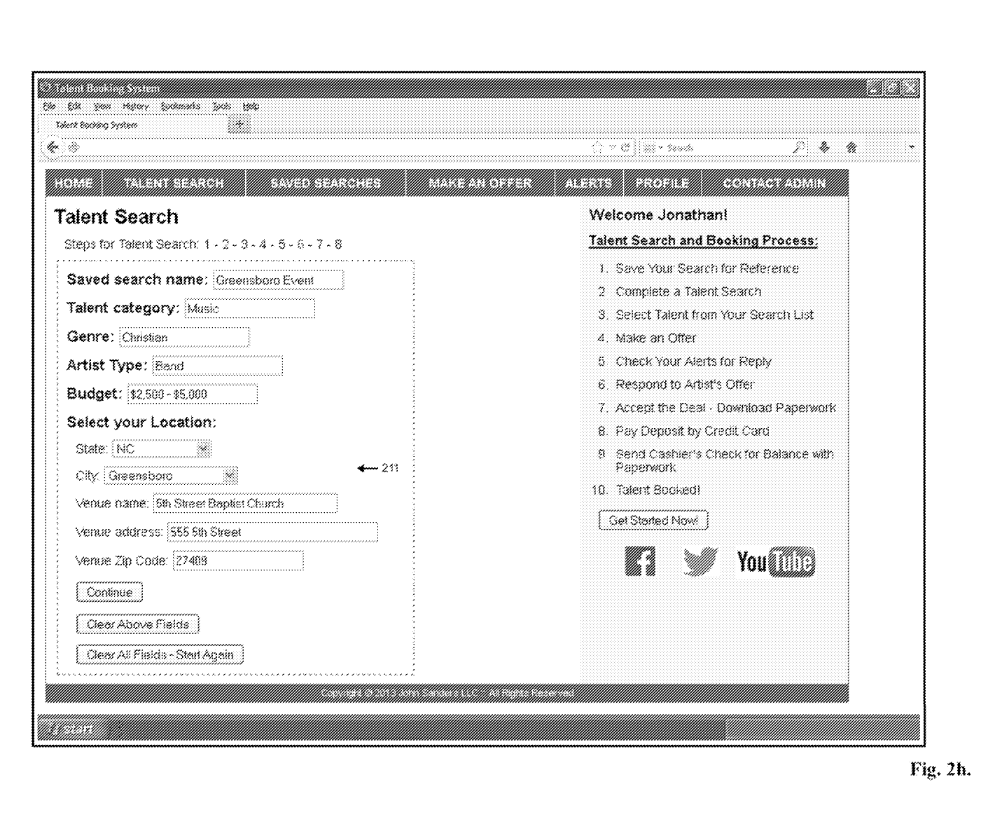

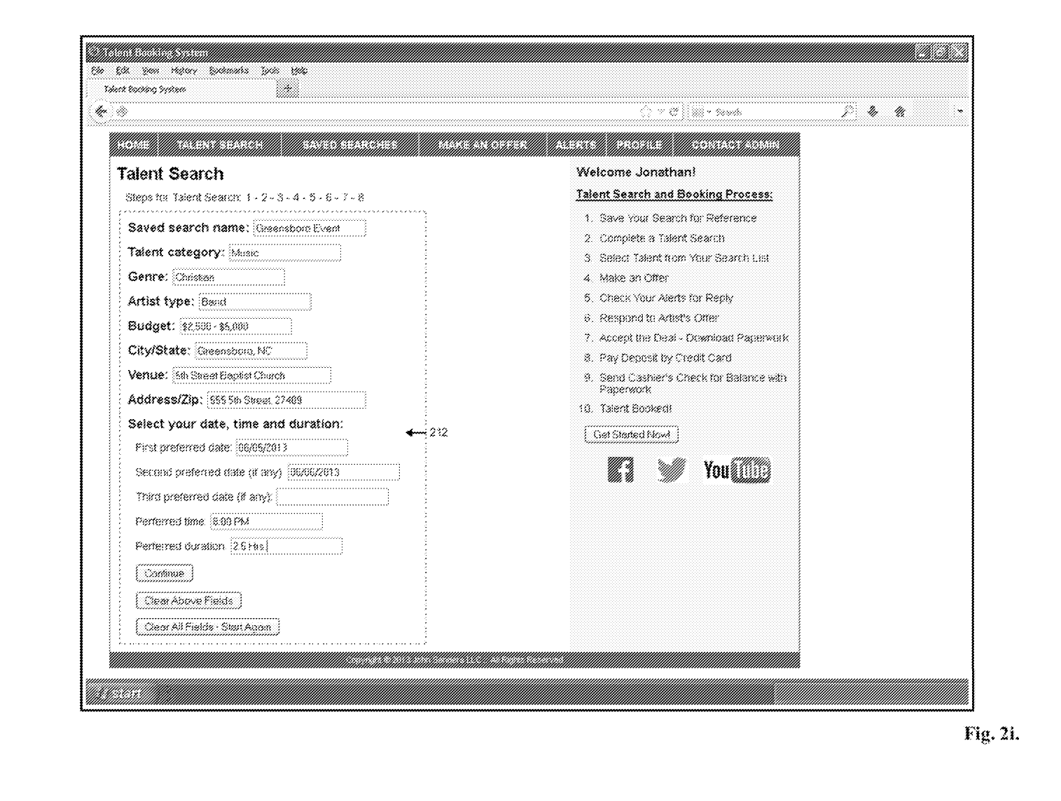

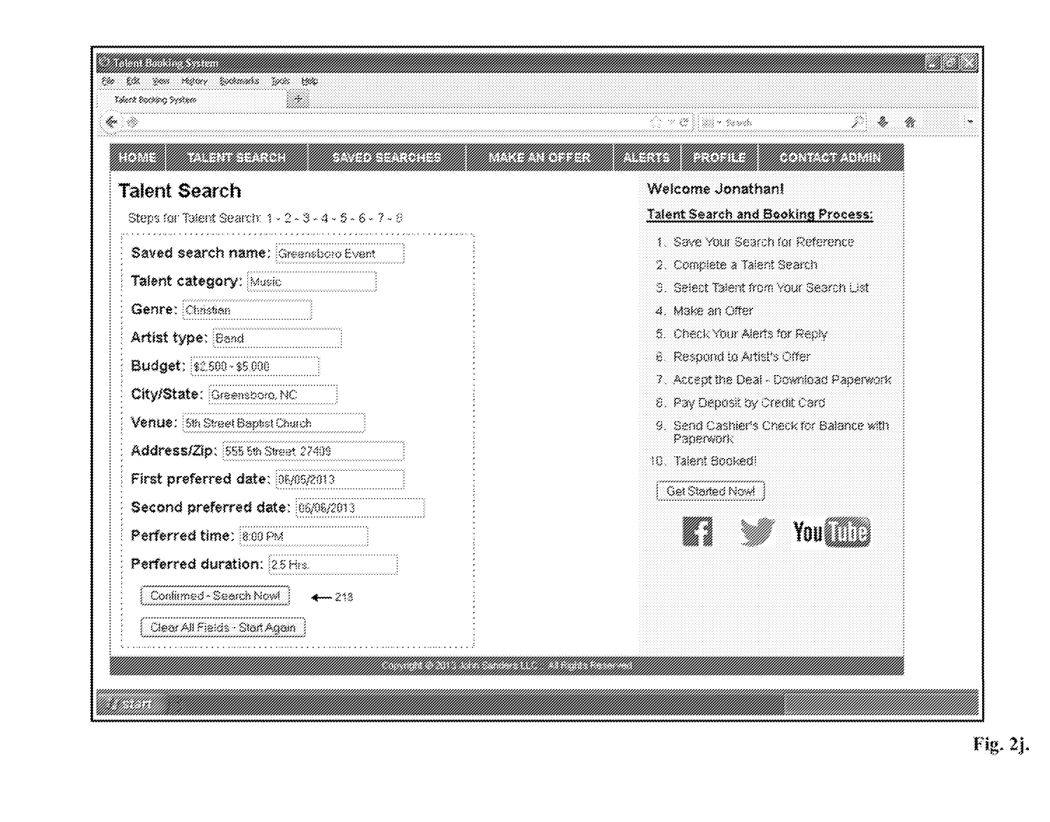

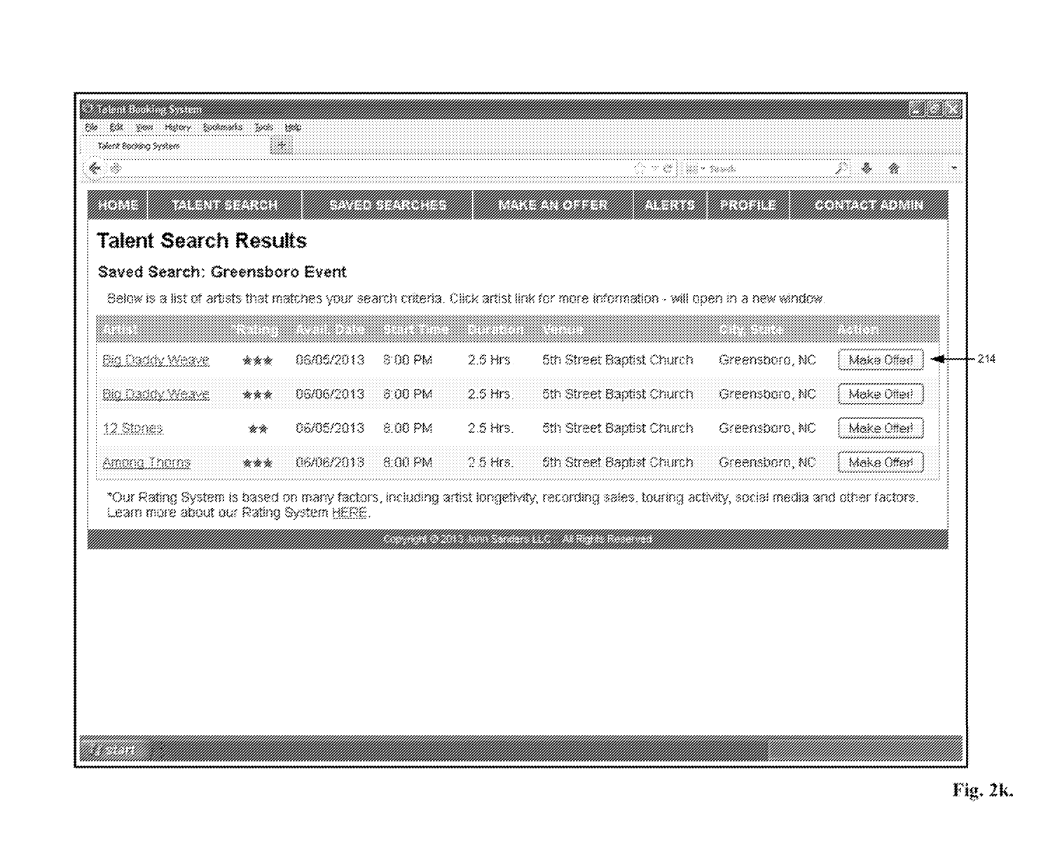

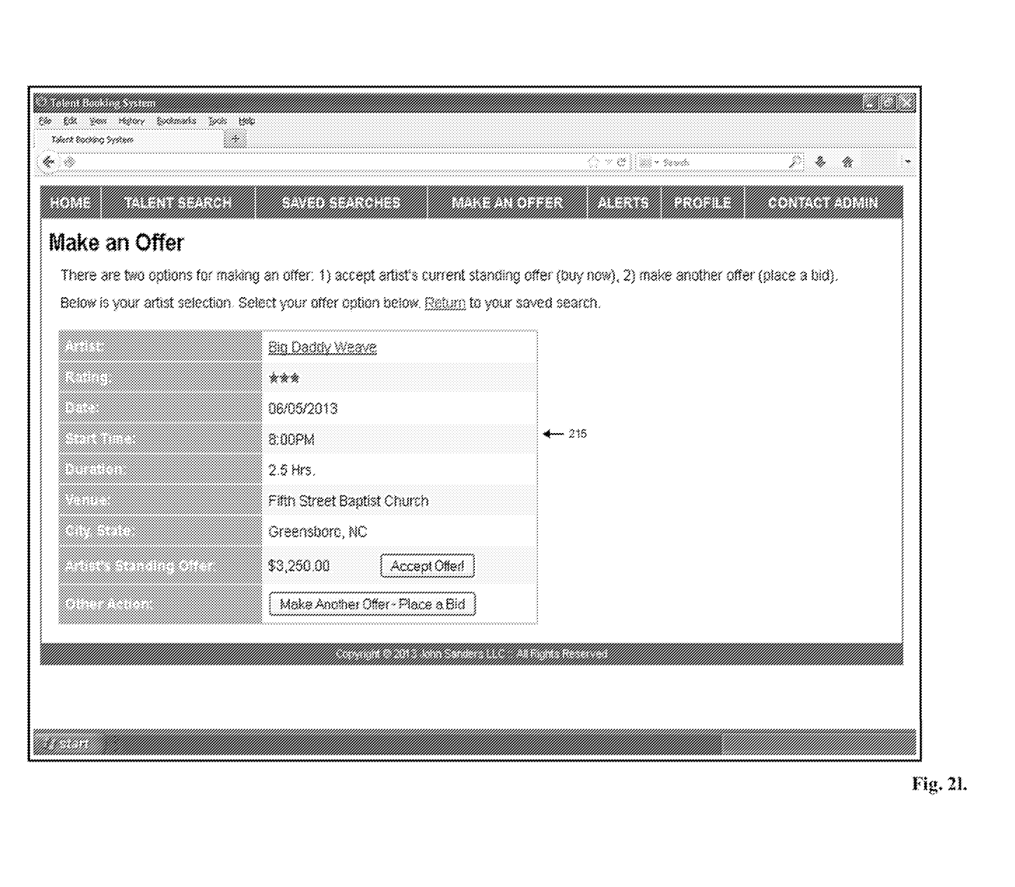

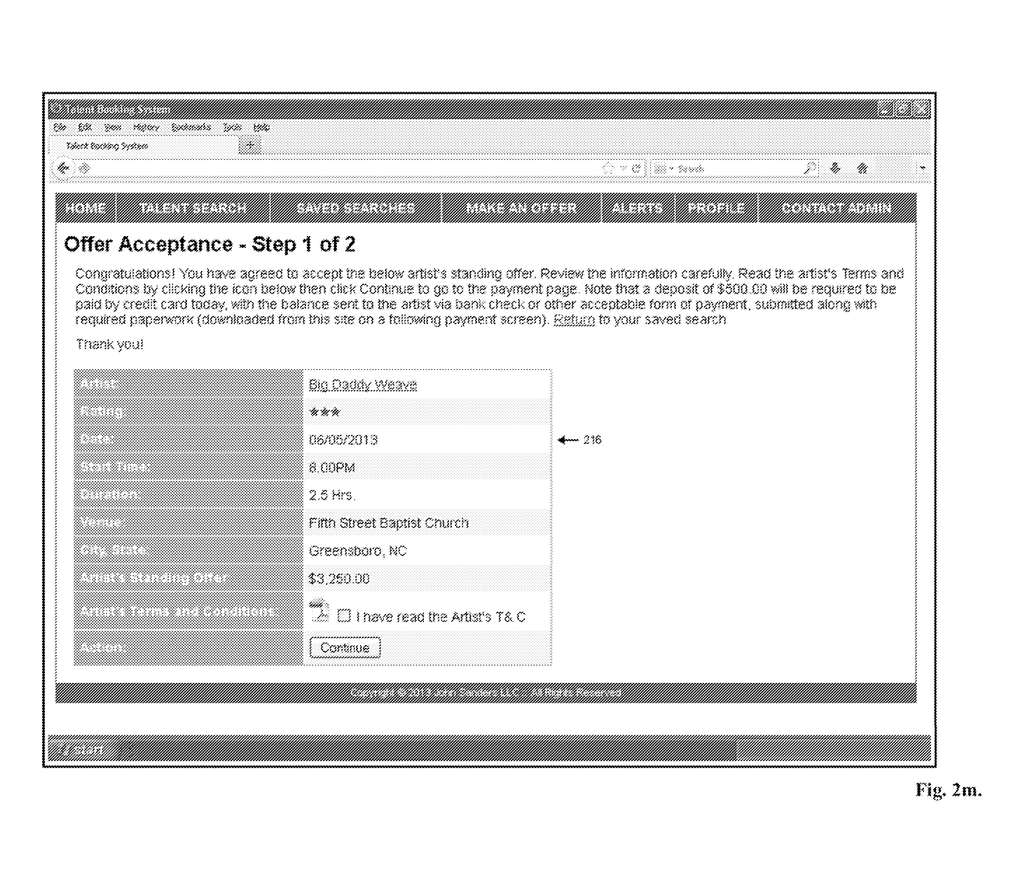

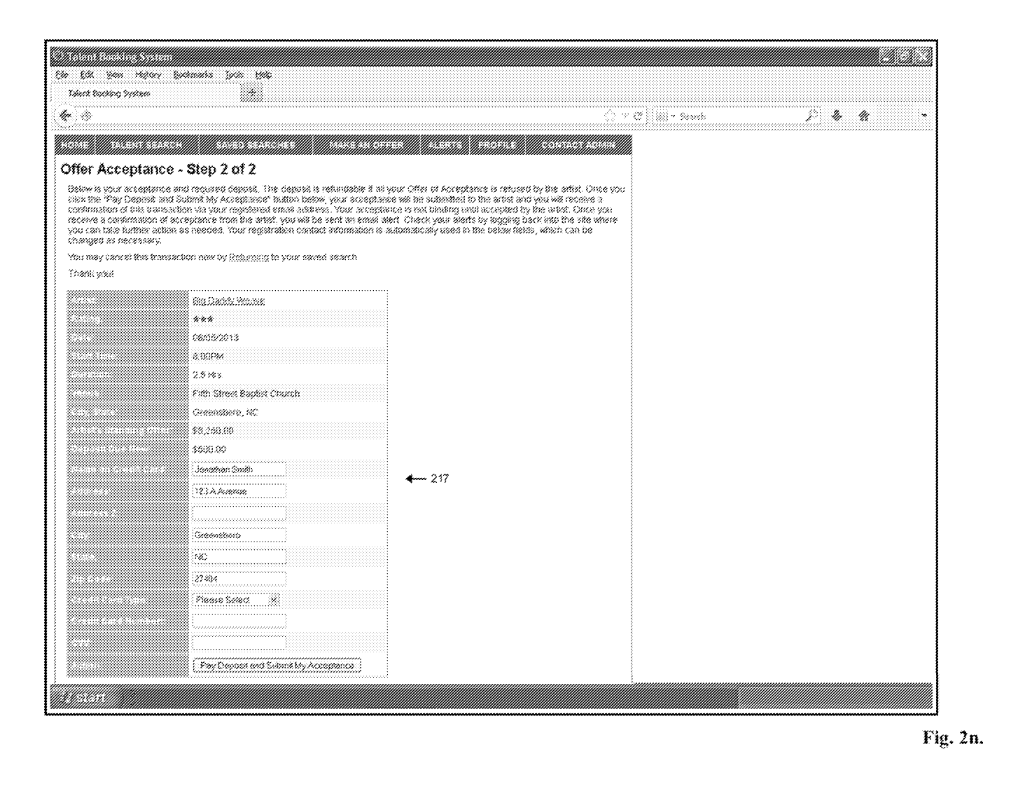

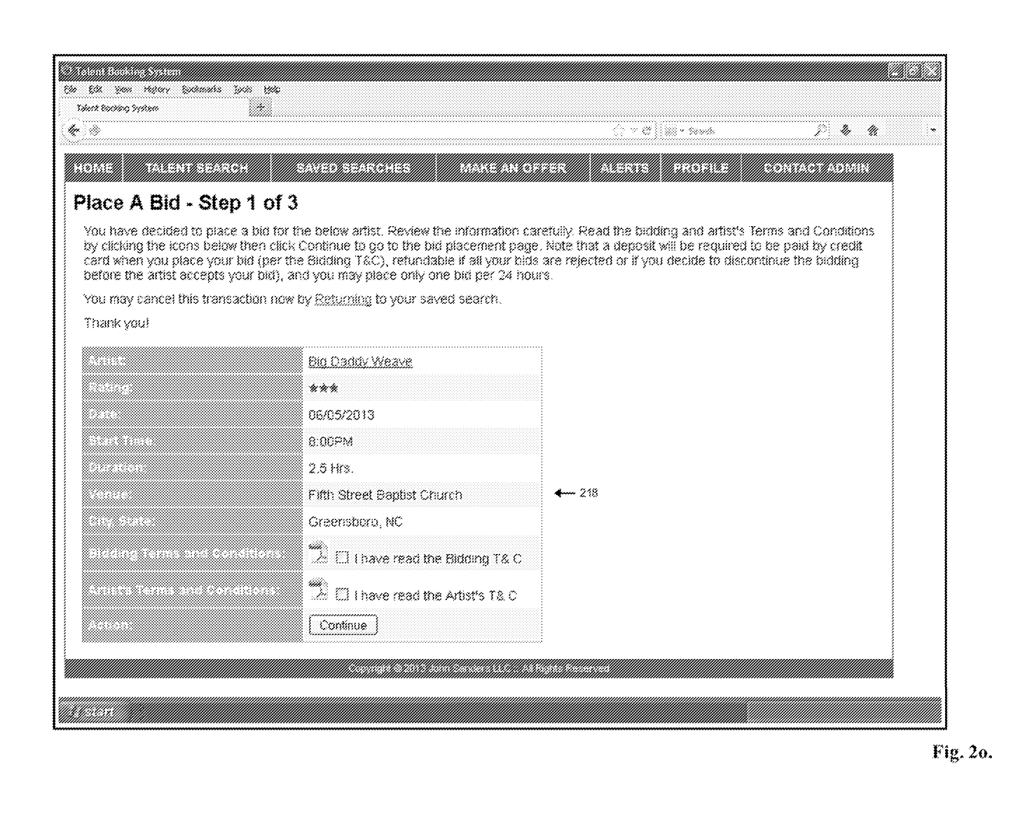

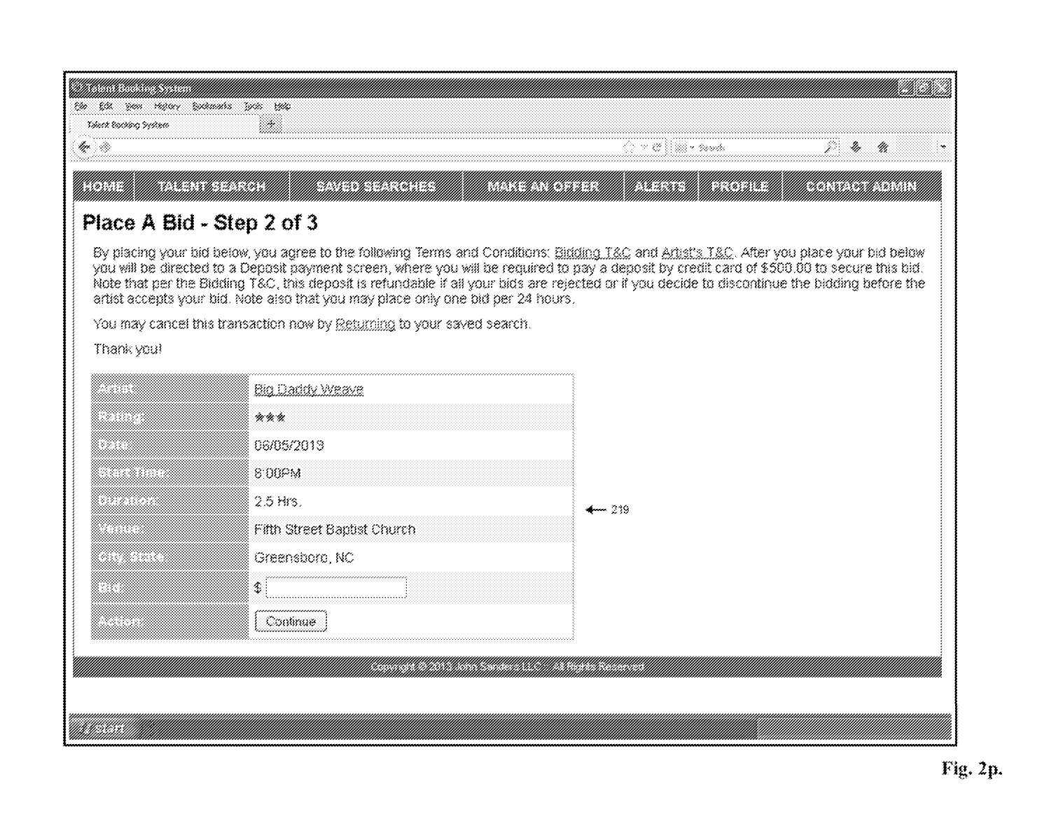

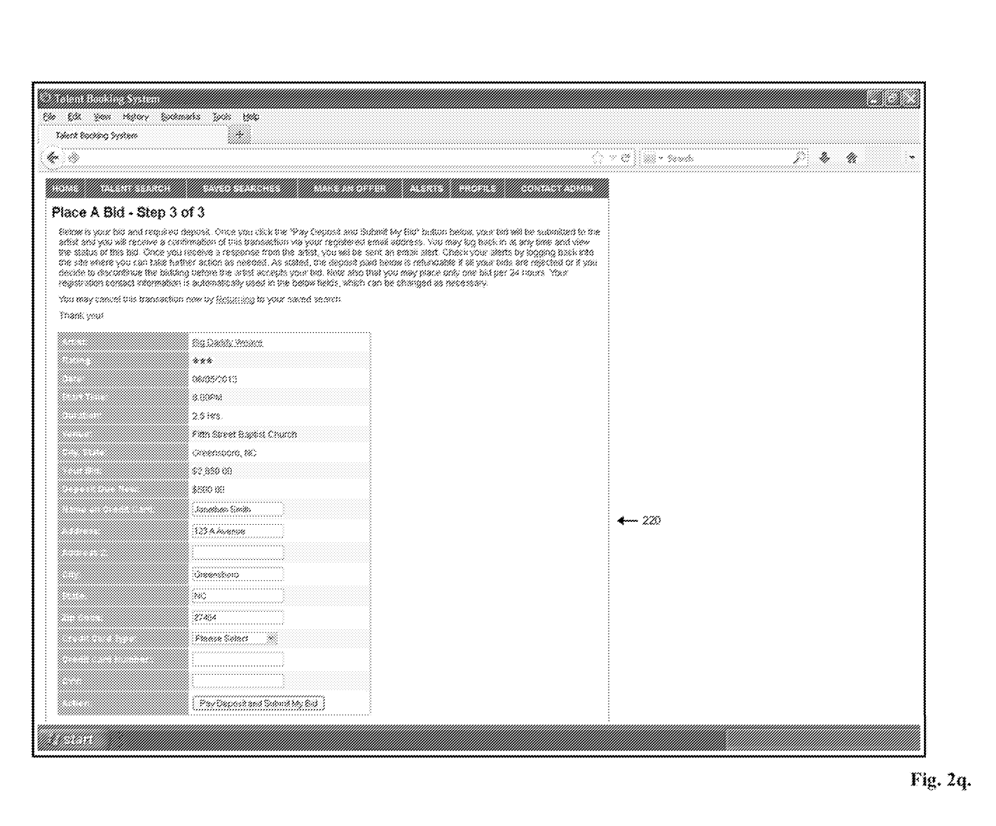

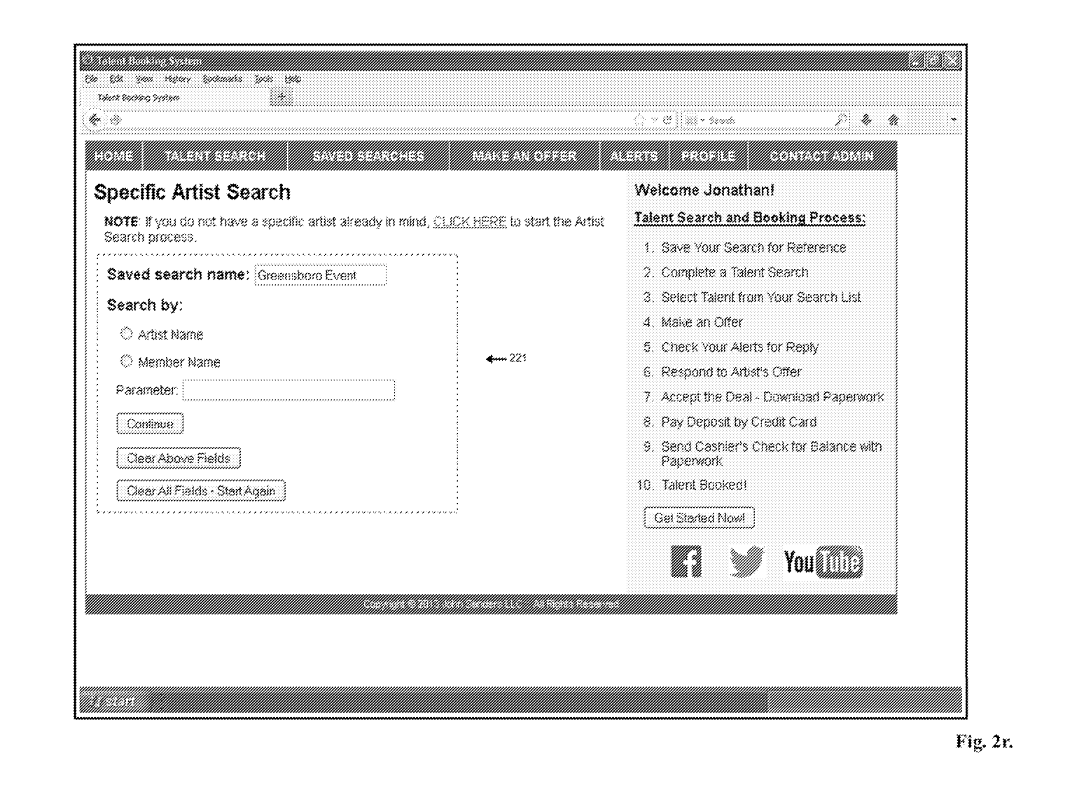

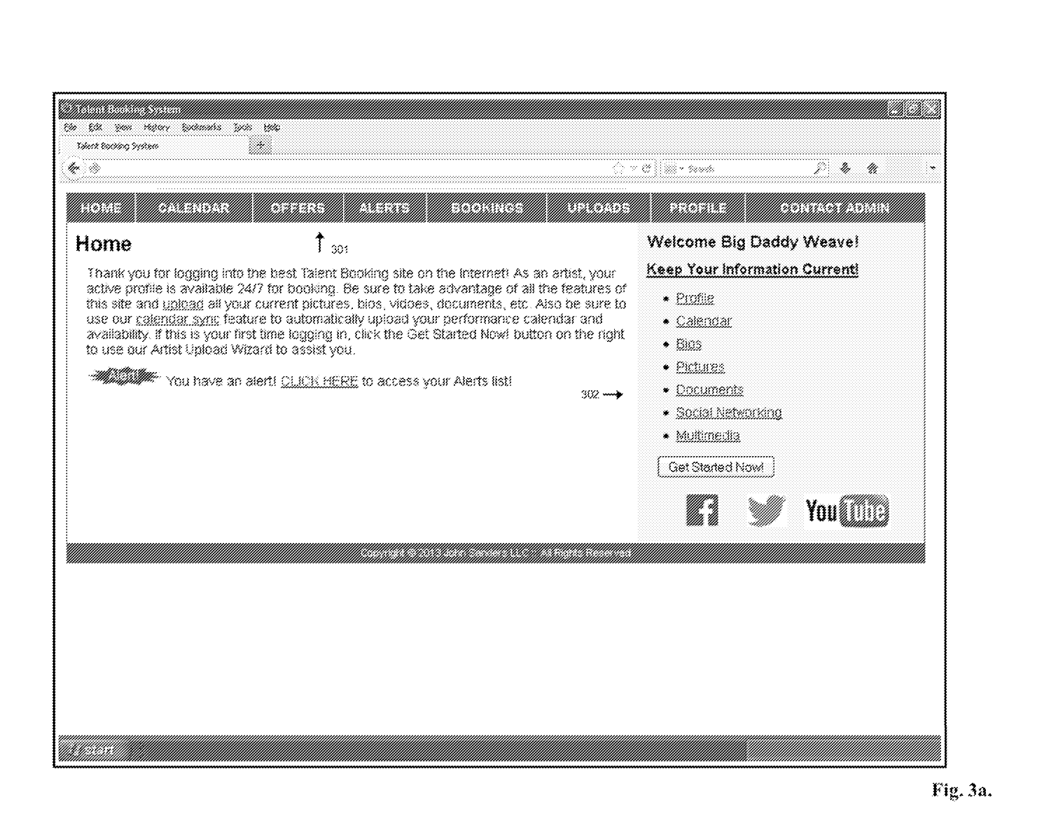

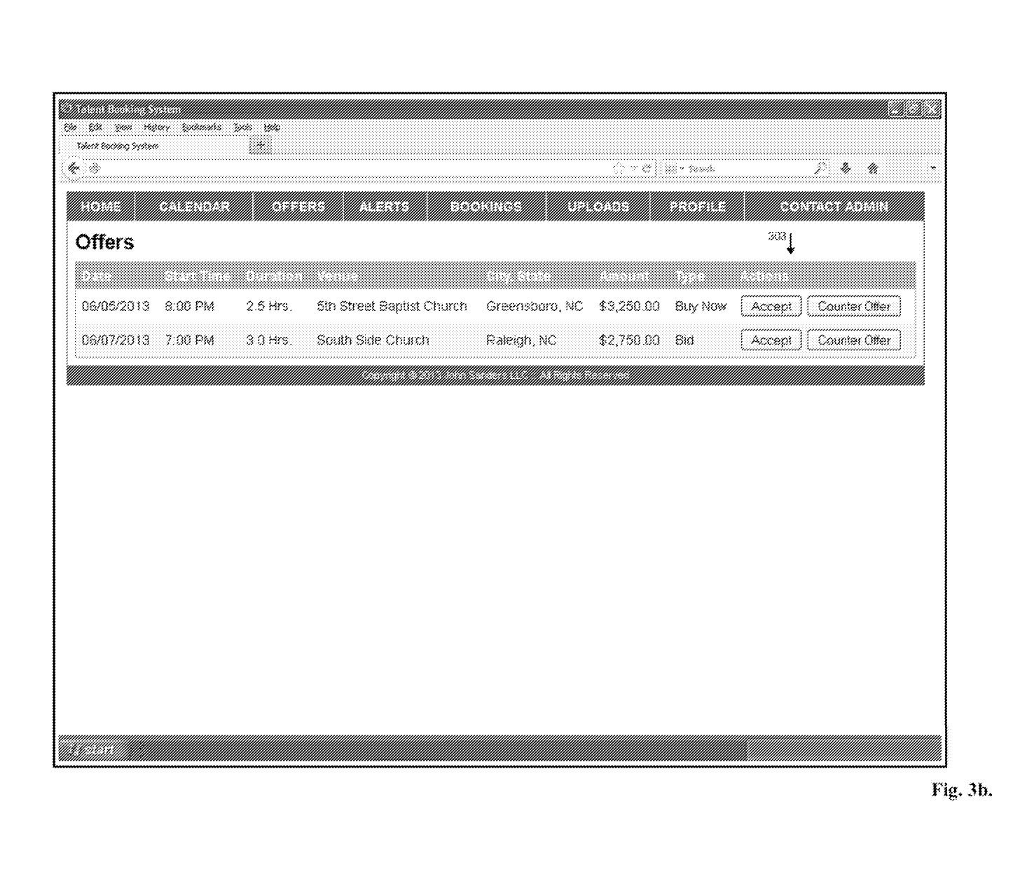

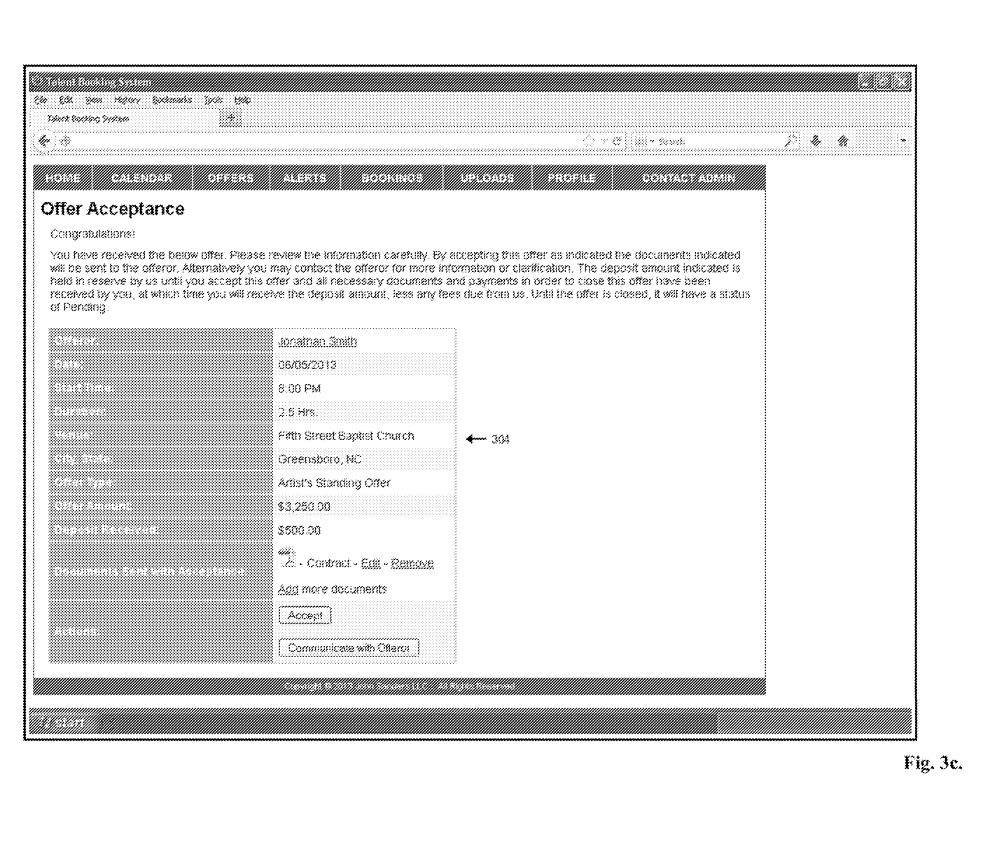

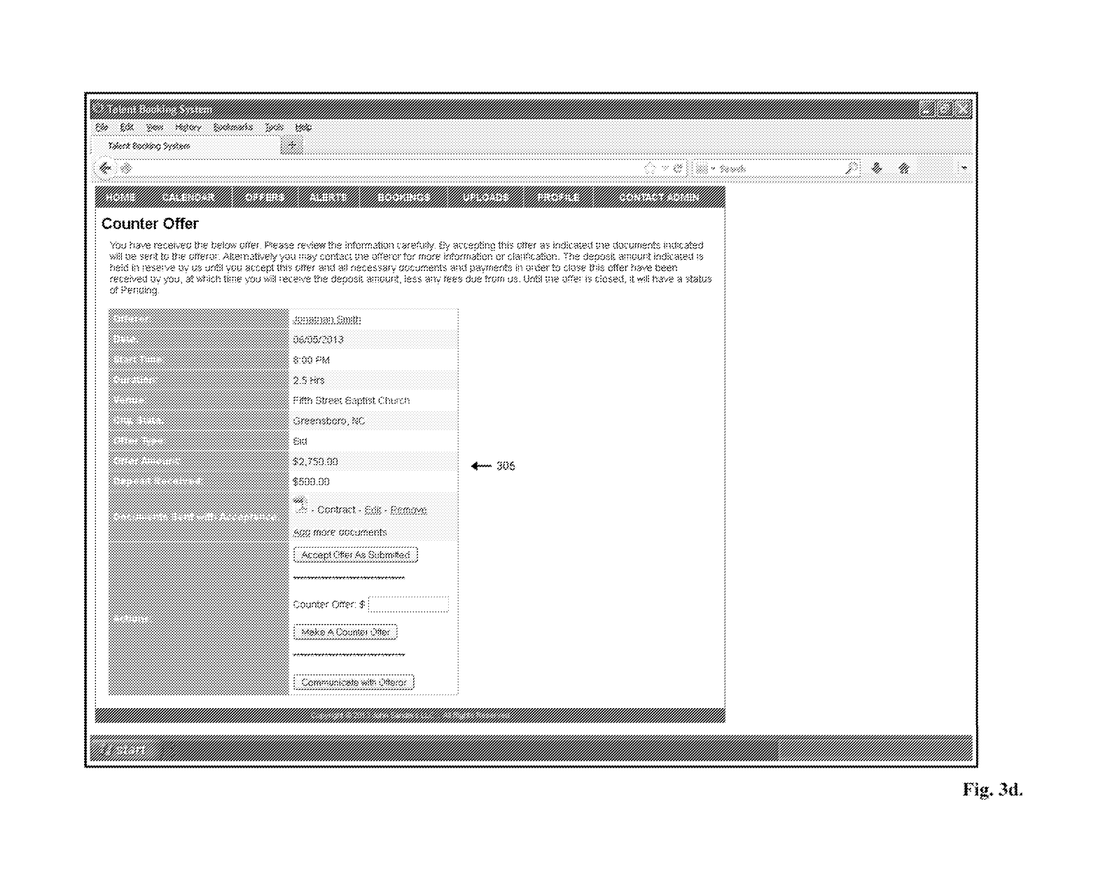

FIGS. 2a through 3d are example displays from an Internet browser accessing the software system and method which may be implemented to execute the elements of the present invention. For example, FIG. 2a depicts a common Internet browser environment which includes key features and functionality of the talent booking system, including a login screen 201 required for registered and verified users of the invention. The login screen 201 may include a handy list of steps 203 required to book talent, such as the list shown on the right side of the screen.

Once the registered end user is logged into the system, a Home landing page, such as the one shown in FIG. 2b is displayed. The landing page, as well as most or all of the other pages within the system, may include a menu bar 202 with functions representing Home, Talent Search, Save Searches, Make an Offer, Alerts, Profile, and Contact Administrator, although variations on this arrangement are possible. The Home page may include a “talent spotlight” featuring a certain artist that can be booked through the system, along with links to the artist's schedule. The Home page may also show the steps 203 in the booking process, as well as alerts for the user, corresponding to booking activities and offers. Social media links may also be included for posts related to the talent booking activities.

In FIG. 2c, when the user selects the Talent Search option of the menu bar 202, or possibly the Get Started Now button, a display is presented which allows the user to begin a search for talent. The steps for completing a talent search are numbered for easy reference, e.g. the end user will see his position in the process indicated by a highlighted number 204 in the sequence. The first step in the talent search process is to save the event name 205 in the database. Each activity related to this search will automatically be saved as each process step is completed.

FIG. 2d depicts a more detailed search display 206 that is presented to the user after saving the event (saved search) name from FIG. 2c, which represents Step 2 in the talent search process. For reference, those previously saved fields 207 will appear in the top section of the search fields screen. In this step, a talent category may be selected, including selections for Music, Comedy, Speaker, Magician, or Other (which may allow an additional text field more specific information). In this case, a selection of Music has been made. The user is also provided with options for saving these selections and/or clearing the above fields. Importantly, this search method is useful when the user does not have a specific artist in mind, because it allows a search for various artists satisfying the search criteria. However, if a specific artist is desired, this display may include a link to the “Specific Artist Search”, more fully described with respect to FIG. 2r below.

FIG. 2e depicts Step 3 in the talent booking process, in which the user identifies other details which are based upon the selection made in Step 2. For example, since Music was selected in Step 2, the user is presented with options 208 regarding the specific genre of Music, including Christian, Pop, Rock N Roll, Country, Soul, or Other.

Similarly, FIG. 2f depicts Step 4 in the talent booking process, in which the user identifies other details which are based upon the selection made in Step 3. For example, since Christian was selected in Step 3, the user is presented with options 209 regarding whether a band or single artist is preferred, or whether there is no preference. In this example, a band is selected by the user.

FIG. 2g then represents Step 5 in the talent searching process which allows the user to select a budget 210, typically represented by ranges in dollar amounts. In this example, the budget range of $2,500-$5,000 is selected.

FIG. 2h depicts Step 6 in the talent searching process which requests information about the performance location 211. Notably, separate searchable fields for state, city, and zip code are also provided.

FIG. 2i depicts Step 7 in the talent searching process which requests information about the duration of the performance and first, second, and third preferences on the date of the performance 212.

FIG. 2j depicts Step 8 in the talent searching process which previews all of the relevant input data entered by the user as the basis for the search. A confirmation and search button 213 is provided, whereupon selection of the button 213 executes the search.

FIG. 2k depicts a screen display presented to the user in which artists corresponding to the search criteria are listed 214. The list should identify the artist, the dates when they are available, and preferably the artists' ratings based on the internal rating system within the talent booking system. The rating system is based on a plurality of factors, including longevity, recording sales, touring activity, and comments from social media. Adjacent to each artist in the list, a “Make an Offer” button is present which directs the user to the Make an Offer page.

FIG. 2l depicts the Make an Offer page, presenting information to the user about the selected artist 215. Some artists will provide standing offers which can be selected immediately, in which case the artist's offer is accepted without any further negotiation. However, if the user declines the artist's standing offer, he can select the “Make Another Offer—Place a Bid” button.

FIG. 2m depicts the display presented to the user when the “Accept Offer” button from FIG. 2l is selected, and the artist's standing offer is accepted 216. The display provides a link to the artist's terms and conditions, along with a check box to indicate the user's agreement to the artist's terms. This display also informs the user of any deposit that must be paid prior to booking the talent, as well as a Continue button to accept the details for the artist and the proposed performance.

FIG. 2n depicts the secure payment screen in which the user provides credit card payment information 217 and submits the offer acceptance to the artist for consideration. A confirmation email of the payment is sent to the user, and the user then waits for a response by the artist by checking the Alerts feature. The user may also receive an automated email from the talent booking system notifying him if the offer has been accepted by the artist. If the artist rejects the event for any reason, the user is alerted, and the deposit amount is refunded to the user.

If the user decides to make a bid for the artist, rather than accept the artist's standing offer, the user would select the “Make Another Offer—Place a Bid” button from FIG. 2l. Selection of this button brings the user to the display of FIG. 2o, which provides a link to the bidding terms and conditions and a check box to signify the user's agreement to those terms 218. Once the bidding terms and the artist's terms are agreed to by the user, the Continue button is selected to complete Step 1 in the Place a Bid process. FIG. 2p depicts the next step in the Place a Bid process, wherein the amount of the bid is entered by the user in the bid field 219. After entering the amount, the Continue button is then selected to complete Step 2 in the Place a Bid process.

FIG. 2q depicts the final step in the Place a Bid process, wherein a secure payment screen 220 is provided to the user. The user provides credit card payment information for the applicable deposit and submits the bid to the artist for consideration. A confirmation email of the payment is sent to the user, and the user then waits for a response by the artist by checking the Alerts feature. The user may also receive an automated email from the talent booking system notifying him whether the offer has been accepted by the artist, or whether a counter-offer from the artists has been received. If no artist responds to the bid within a predetermined amount of time, the user is alerted, and the deposit amount is refunded to the user. If necessary, the user may be restricted from placing multiple bids within a certain amount of time, such as a single bid within a 24-hour period.

FIG. 2r depicts a “Specific Artist Search” display presented to the user upon selection of the link in FIG. 2d. The user has the option to search on either the artist name or the name of a band member 221, as well as an additional parameter field that may contain information specific to that artist. When the Continue button is selected, displays similar to those shown in FIG. 2h and FIG. 2i are provided so the user can define the location, date, and other information to the artist for consideration.

FIG. 3a depicts the display presented to a registered artist user of the talent booking system. When the system recognizes the user as an artist, the system displays the artist's name, and the menu bar 301 provides options which are relevant to artists, such as Home, Calendar, Alerts, Bookings, Profile, and Contact Administrator. A number of links are provided on the right side of the display for frequently used selections, including profile editing, calendar syncing, biographical data, photographs and videos, documents, and social networking.

FIG. 3b depicts a display of the current offers that are available to the artist, identifying them as either acceptances of the artist's standing offer terms, or as bids. In each case, the display provides an Accept button or a Counter Offer button 303. Selection of the Accept button from FIG. 3b causes a more detailed display 304 to be presented to the artist for that offer as shown in FIG. 3c, and the artist has the option to edit the terms of the offer, accept the offer, or communicate with the user to discuss any other terms which must be resolved prior to acceptance or rejection.

FIG. 3d depicts a display presented to the artist upon selecting the Counter Offer button of FIG. 3b. The details 305 of the offer are provided, along with a field for entering a counter offer to the user, and an option to communicate with the user on other terms or conditions.

FIG. 4 depicts one example of a Home page displayed to the end user on a mobile device. Although text and graphics are condensed in some instances, the mobile version of the talent booking system would contain substantially all of the features of the system as displayed on non-mobile computers.

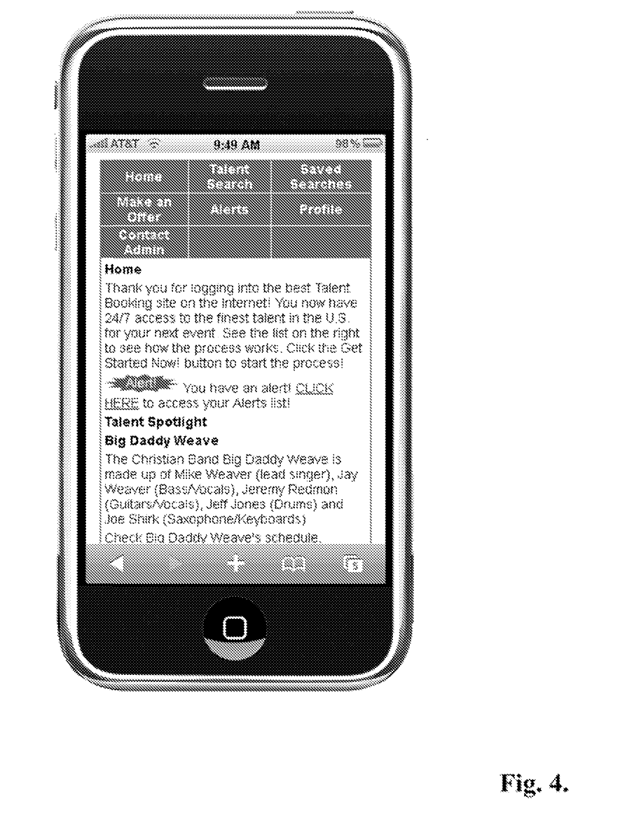

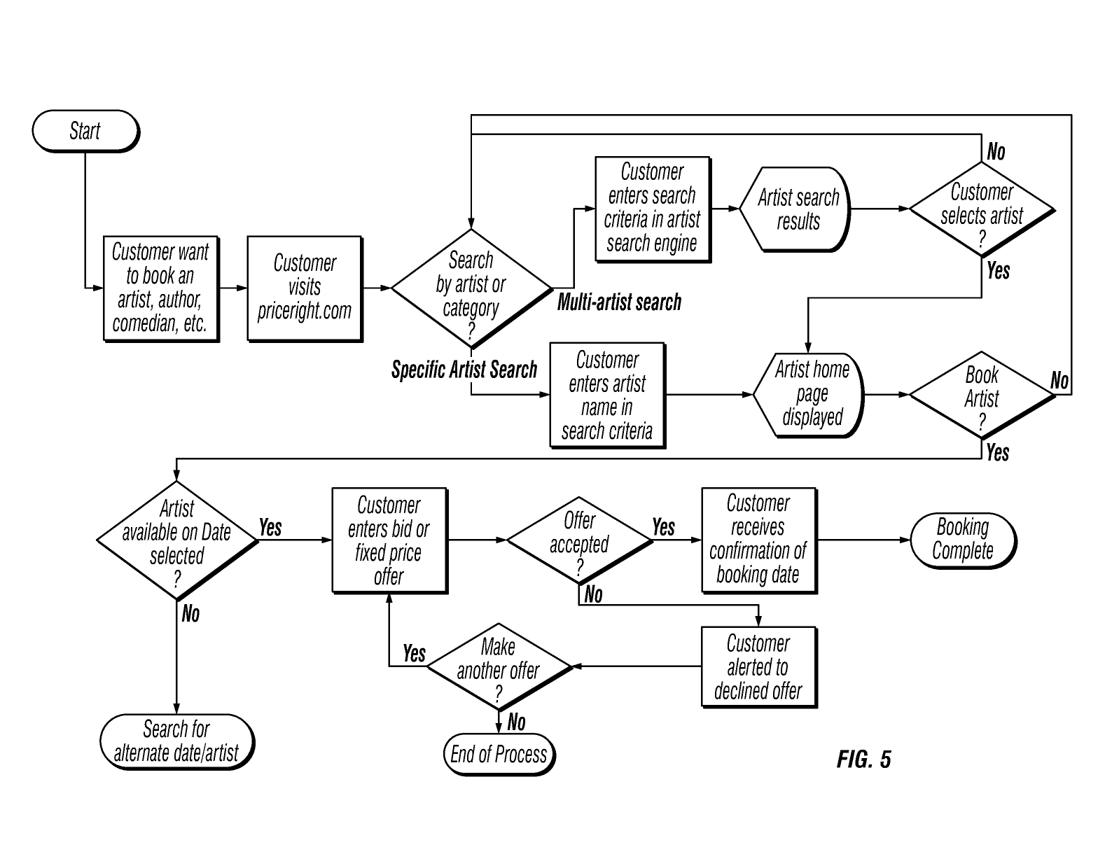

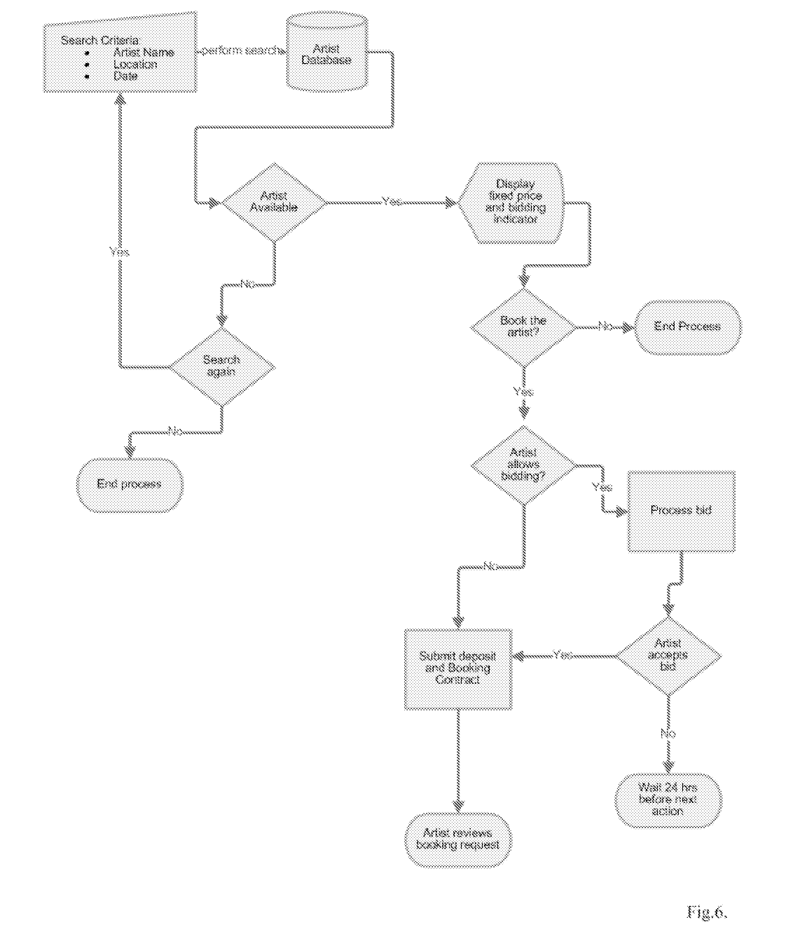

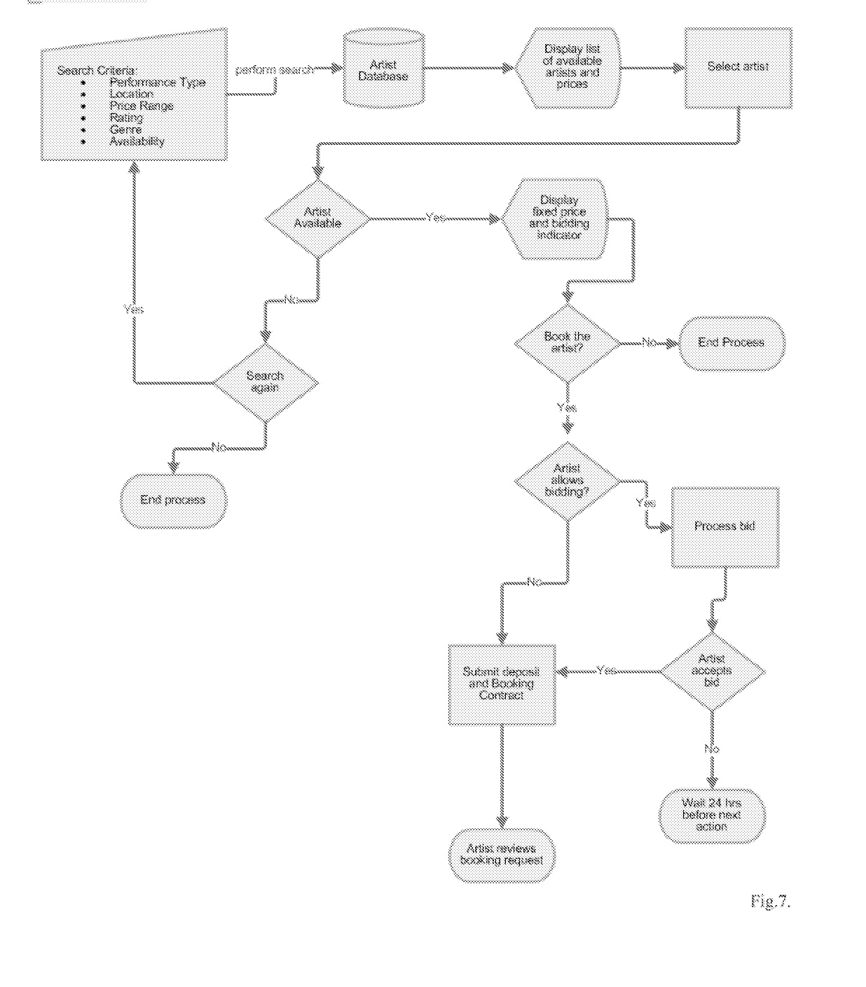

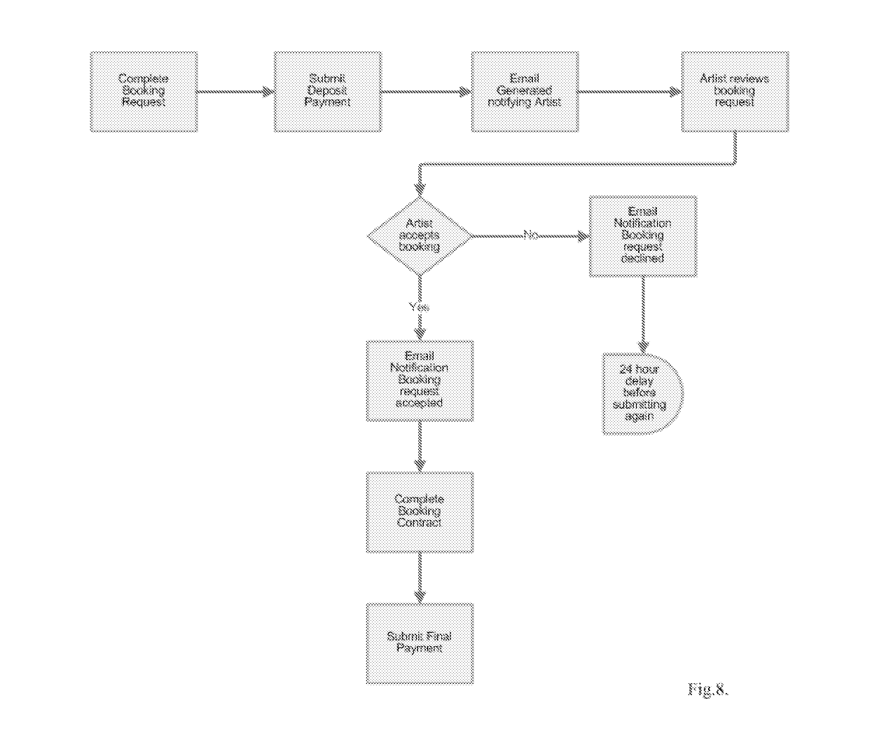

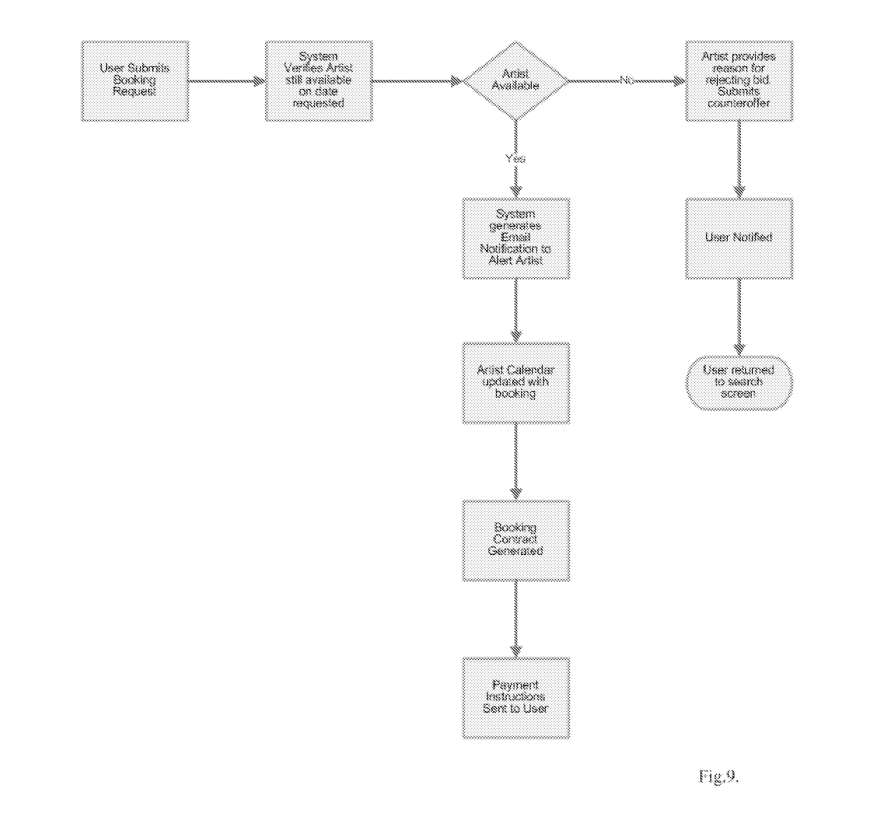

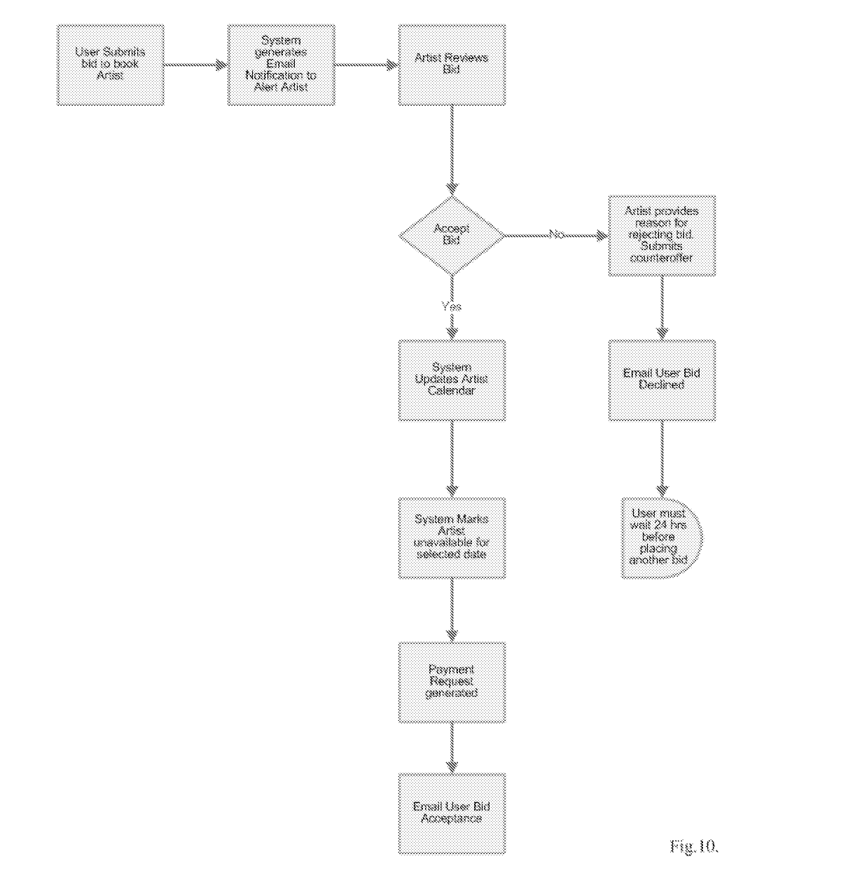

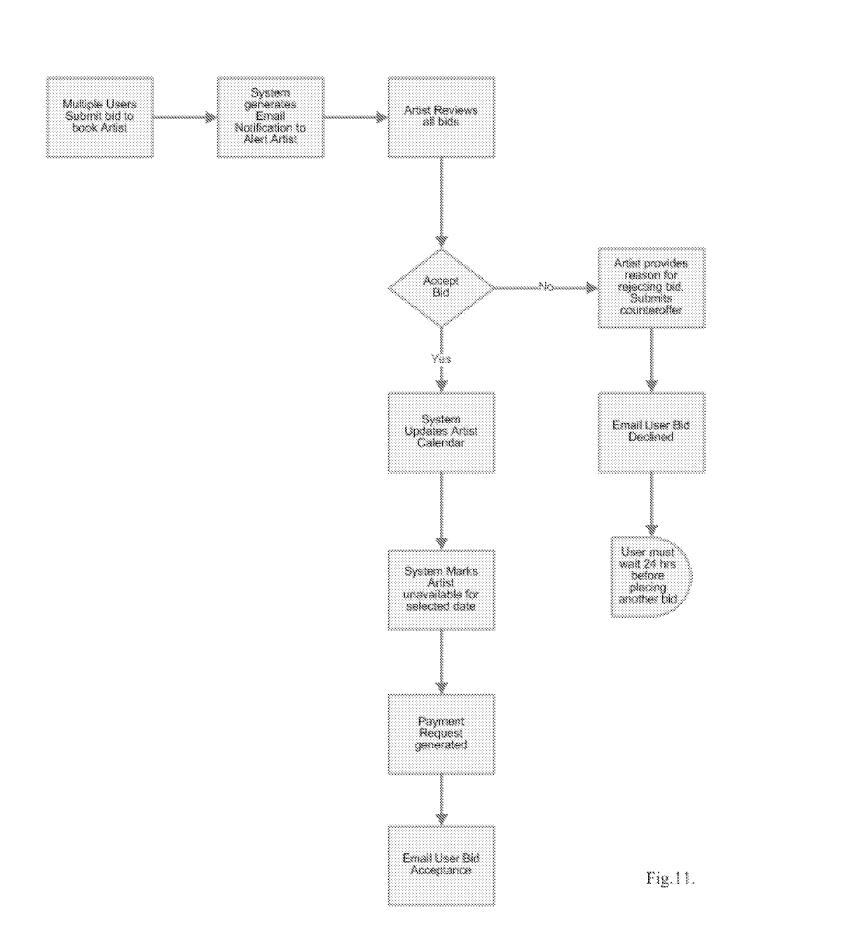

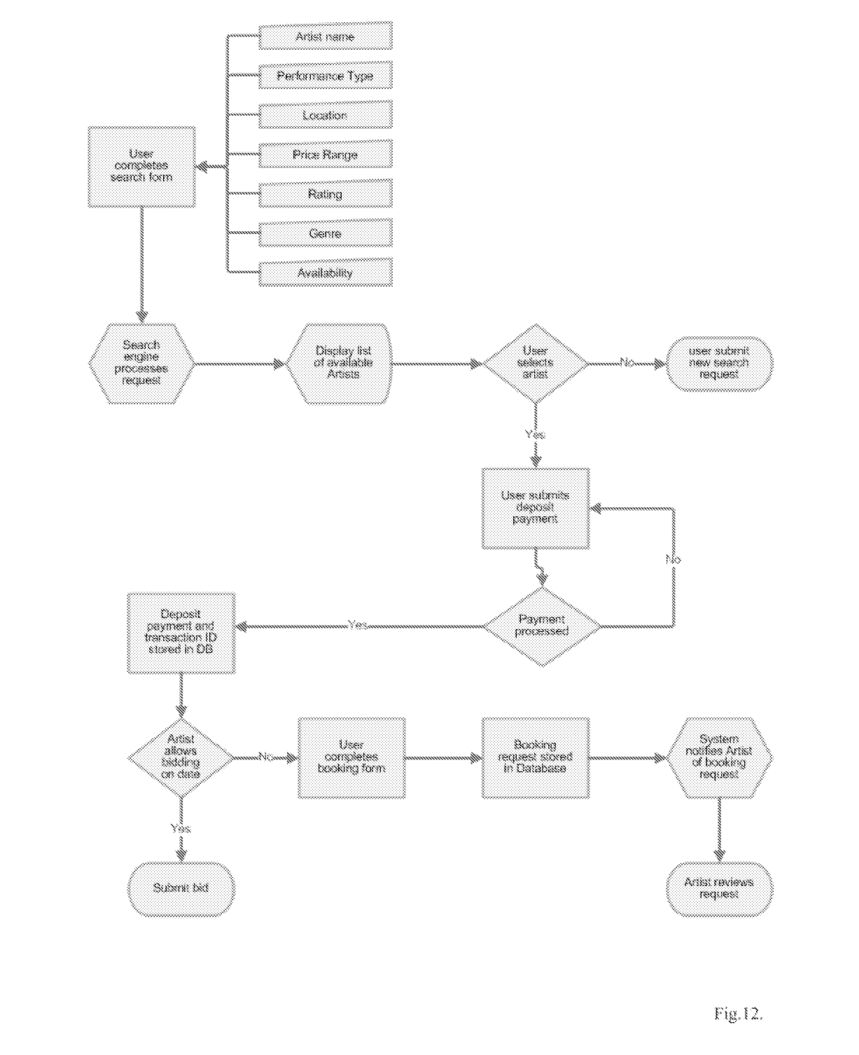

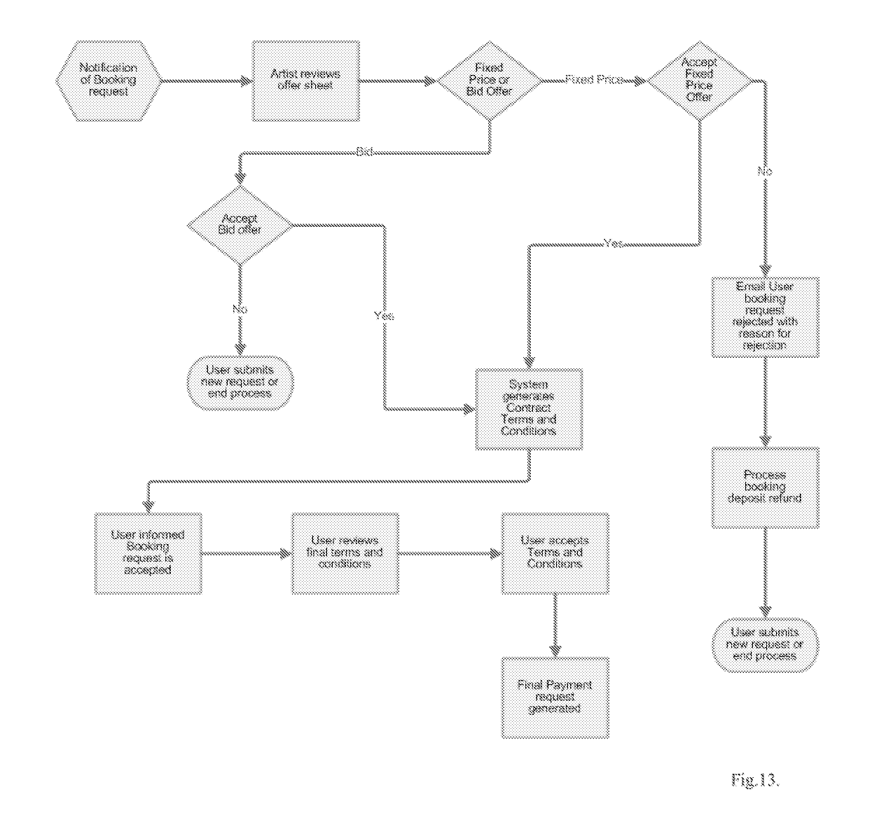

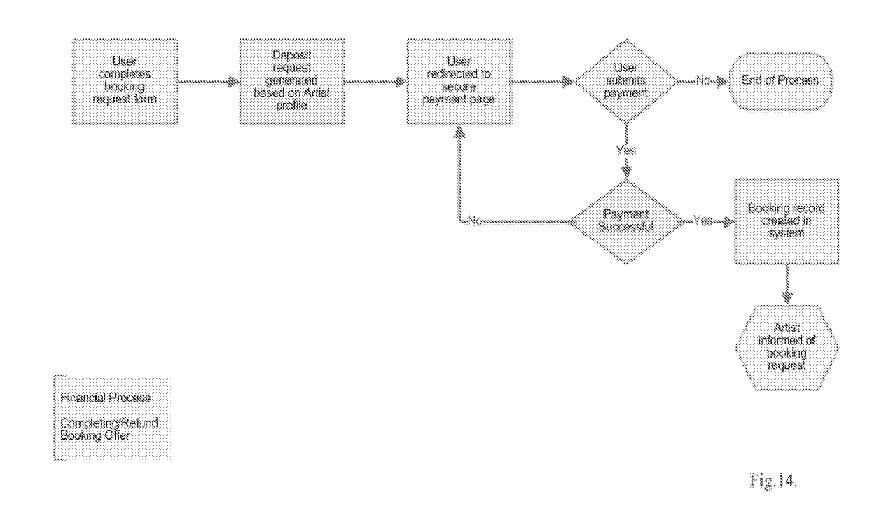

FIGS. 5-14 depict numerous workflow charts which illustrate the sequence of steps and options contained within the talent booking system of the present invention. For example, FIGS. 5-8 show workflow charts which describes the process from the standpoint of an end user who is seeking to book talent for an event. These steps correspond the figures described elsewhere, and namely FIGS. 2a through 2r. FIGS. 9-11 show workflow charts which describe the process from the standpoint of an artist that has received offers from an end user. FIG. 12 shows a workflow chart describing the transactional steps involved when an end user makes an offer to an artist, including processing of any deposit payments and notification of booking requests. Conversely, FIG. 13 shows a workflow chart describing the transactional steps involved when an artist considers and/or accepts an offer from an end user, including payment and refund processing. Finally, FIG. 14 shows a workflow chart describing the steps from the end user standpoint when a booking request is made and the deposit payment is processed.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

The invention claimed is:

1. A system for booking talent, comprising:
(a) a data storage system for storing a plurality of talent files, each of the talent files being categorized based on select criteria, and wherein each talent file contains talent information associated with one of a plurality of performing artists;
(b) a processing device operatively coupled to the data storage system for processing requests for the talent files and the talent information;
(c) a user interface operatively coupled to the processing device for communicating the requests for the talent files and the talent information, and for communicating the talent files and talent information to a system user;
(d) an access control system operative with the processing device for enabling access to the stored talent file by an authorized system user; and
(e) a booking means for enabling the system user to make an offer to one or more of the performing artists for a performance having specified terms, and for enabling an electronic monetary transaction related to the offer to be consummated between the system user and the performing artist.

2. The system of claim 1, further comprising searching means for enabling the system user to conduct a search of the stored talent files based on the select criteria, and for creating search results; and search output means for outputting the search results to the system user.

3. The system of claim 1, wherein the access control means comprises means for enabling the system user to access one or more of the talent files for a limited period of time.

4. The system of claim 1, wherein the access control means comprises means for enabling the system user to access one or more of the talent files for a limited number of accesses.

5. The system of claim 1, wherein the access control means comprises means for enabling the system user to access a limited portion of one or more of the talent files.

6. The system of claim 1, wherein the access control means comprises means for enabling the performing artists to:
(a) access and edit their respective talent files;
(b) receive and respond to offers from system users; and
(c) update their schedule, availability, and desired contract terms.

7. The system of claim 1, wherein the booking means further enables a performing artist to accept, reject, or make a counteroffer in response to the offer from the system user.

8. The system of claim 7, wherein the booking means includes a notification device configured to notify the system user of confirmation of a booking, rejection of the offer, or proposed terms of the counteroffer.

9. The system of claim 7, wherein the booking means includes a plurality of predefined booking contract terms and options which are selectable by the system user and the performing artists.

10. The system of claim 1, wherein the select criteria includes at least artist name, performance type, location, price, rating, genre, and availability.

11. The system of claim 1, further including a rating device operatively coupled to the user interface for rating the performance of the performing artists based upon predefined criteria.

12. The system of claim 1, wherein the booking means further enables the system user to make an offer for a specific performing artist corresponding to predetermined criteria set by the performing artist.

13. A method of booking talent, comprising:
(a) storing a plurality of talent files on a data storage system, each of the talent files being categorized based on select criteria, and wherein each talent file contains talent information associated with one of a plurality of performing artists;
(b) searching the data storage system through a processing device operatively coupled to the data storage system for processing requests for the talent files and the talent information;
(c) communicating requests for the talent files and the talent information through a user interface operatively coupled to the processing device, and communicating the talent files and talent information to a system user;
(d) selecting one or more talent files for possible booking of the corresponding performing artist;
(e) making an offer to book one or more of the performing artists for a performance having specified terms; and
(f) receiving a response to the offer from the performing artist.

14. The method of claim 13, further comprising:
(a) reviewing the response from the performing artist in the form of an acceptance, a rejection, or a counteroffer;
(b) confirming the booking with the performing artist if the response was an acceptance;
(c) selecting a different performing artist if the response is a rejection; and
(d) accepting or rejecting the proposed terms if the response was a counteroffer.

15. The method of claim 13, wherein the offer for booking and the response by a performing artist are made based upon a plurality of predefined booking contract terms and options which are selectable by a system user and the performing artists.

16. The method of claim 13, wherein the select criteria includes at least artist name, performance type, location, price, rating, genre, and availability.

17. The method of claim 13, further comprising rating the performance of the performing artists based upon predefined criteria.

18. The method of claim 13, further comprising consummating an electronic monetary transaction related to the offer between the system user and the performing artist.
